(19) United States
(12) Patent Application Publication
(10) Pub. No.: US 2009/0216831 A1
(43) Pub. Date: Aug. 27, 2009

(54) Entity identity management system and associated methods

(76) Inventor: George R. Buckner, Raleigh, NC (US)

Correspondence Address: SMITH MOORE LEATHERWOOD LLP, P.O. BOX 21927, GREENSBORO, NC, 27420, US

(21) Appl. No.: 11/284,083

(22) Filed: Nov. 21, 2005

(51) Int. Cl. G06F 15/16

(52) U.S. Cl. 709/202

(57) ABSTRACT

An entity identity management system is disclosed. The entity identity management system includes an identity manager. The identity manager includes a validated database, a confirmation manager, and an interface. The validated database includes entity-controllable data.

In the accompanying drawings:

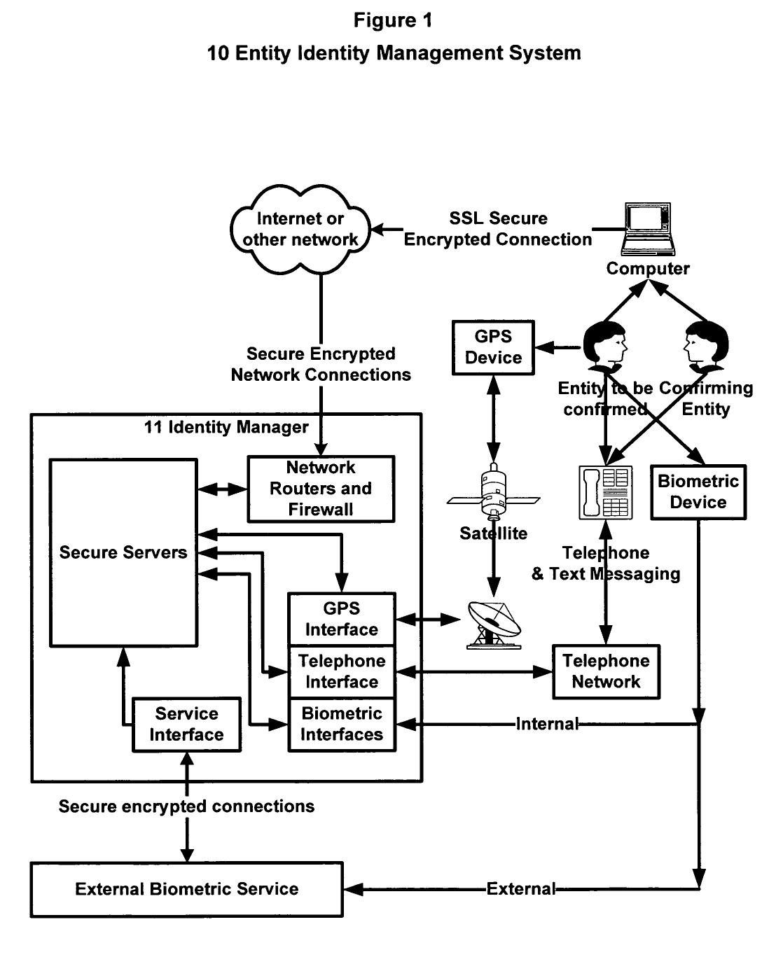

FIG. 1 is a diagram illustrating an entity identity management system according to an aspect of the present invention and usable with any other aspects (whether any other aspect is taken alone or in any combination of aspects) of the present invention as may be illustrated and/or disclosed;

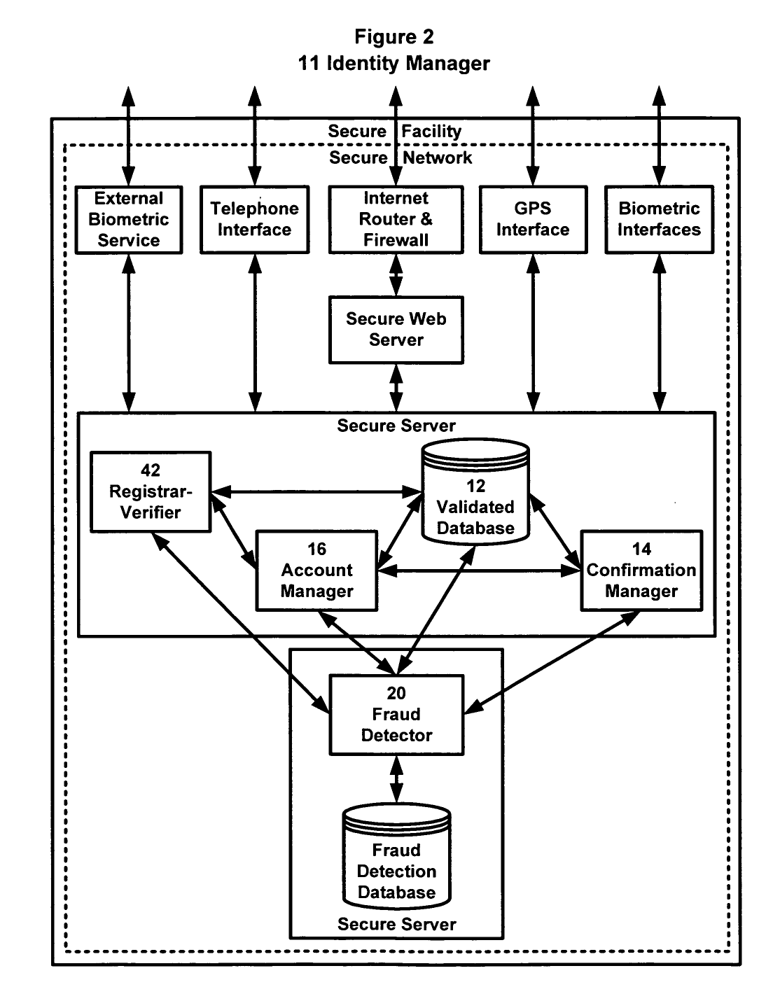

FIG. 2 is a diagram illustrating an example of an identity manager according to an aspect of the present invention and useable with an identity management system of FIG. 1 and/or any other aspects (whether any other aspect is taken alone or in any combination of aspects) of the present invention as may be illustrated and/or disclosed;

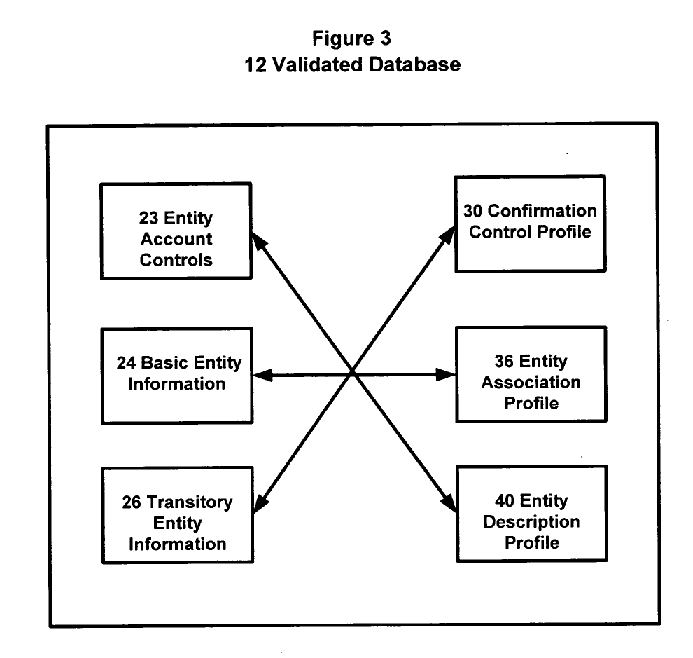

FIG. 3 is a diagram illustrating a validated database according to an aspect of the present invention and useable with any one of an identity management system of FIG. 1, an identity manager of FIG. 2, and/or any other aspects (whether any other aspect is taken alone or in any combination of aspects) of the present invention as may be illustrated and/or disclosed;

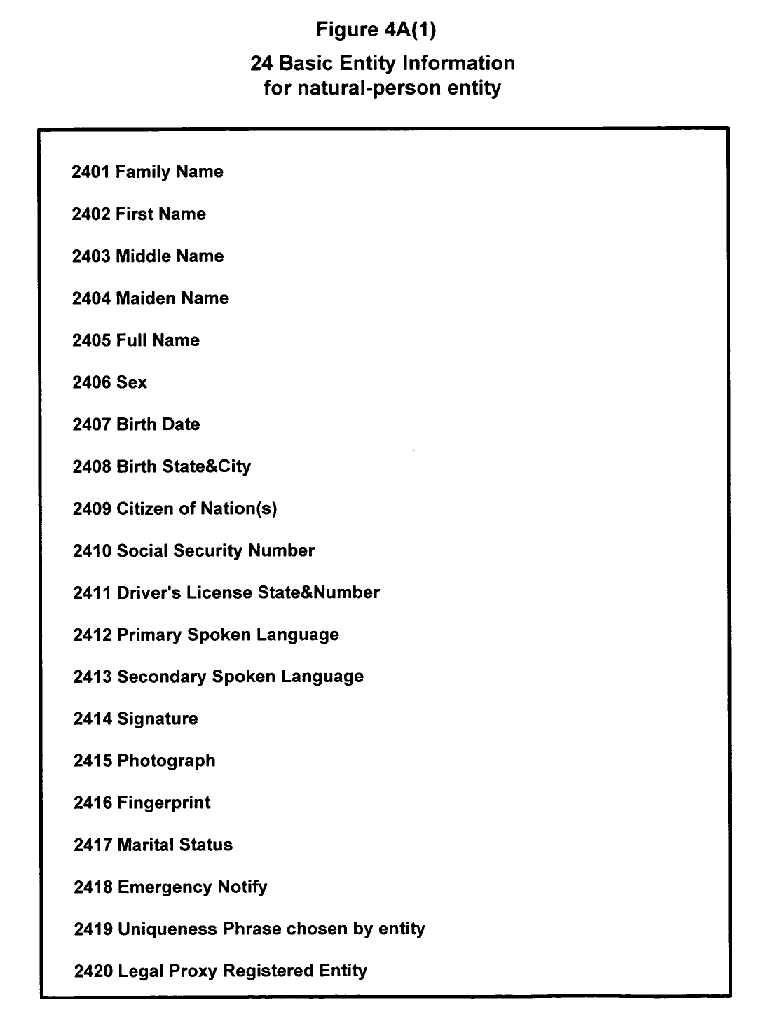

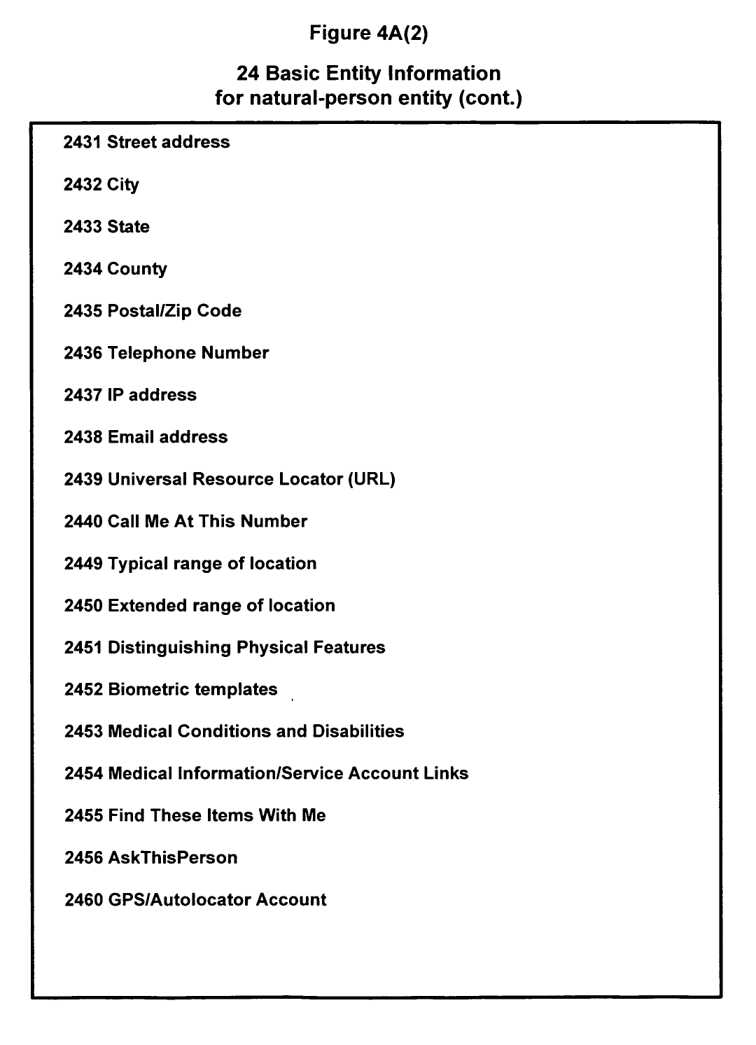

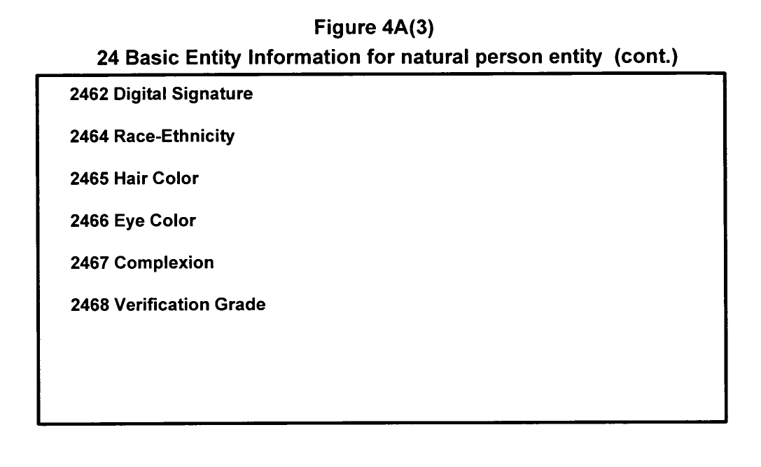

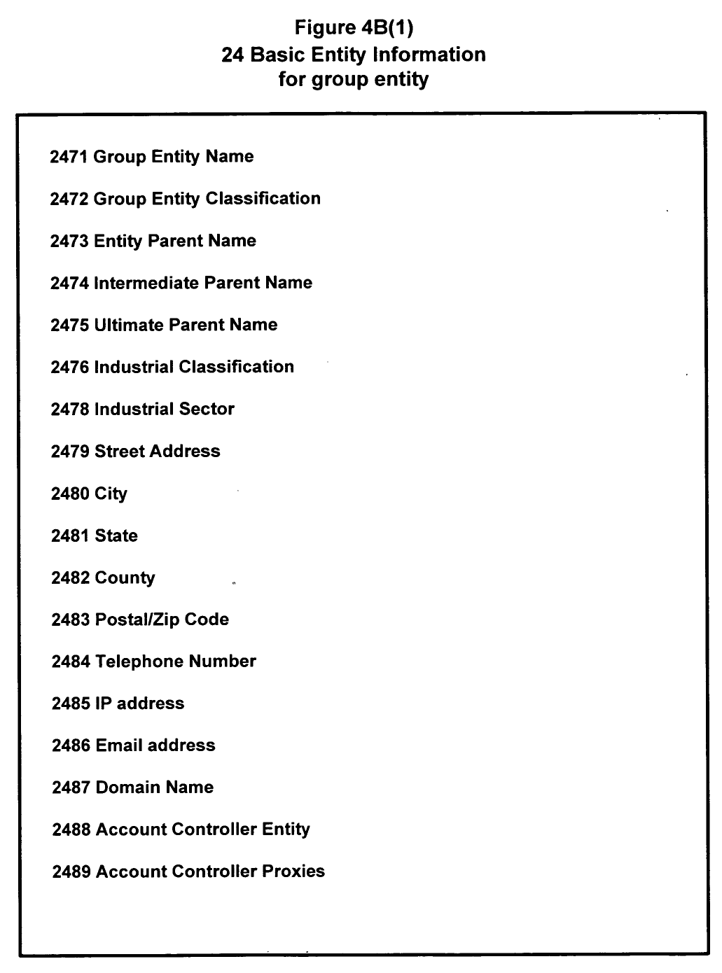

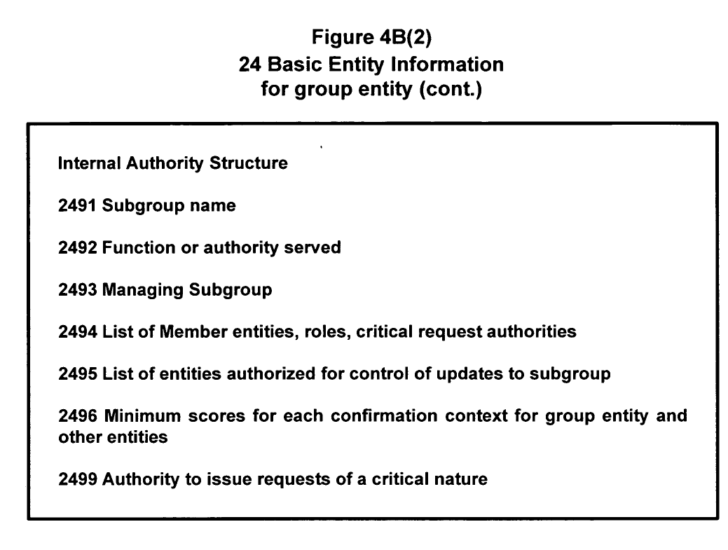

FIG. 4A(1) is a diagram illustrating a part of basic entity information for a natural-person entity according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 4A(2) is a diagram illustrating an additional part of basic entity information for a natural-person entity according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 4A(3) is a diagram illustrating an additional part of basic entity information for a natural-person entity according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 4B(1) is a diagram illustrating a part of basic entity information for a group entity (an entity that is other than an natural-person entity) according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 4B(2) is a diagram illustrating an additional part of basic entity information for a group entity (an entity that is other than a natural-person entity) according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

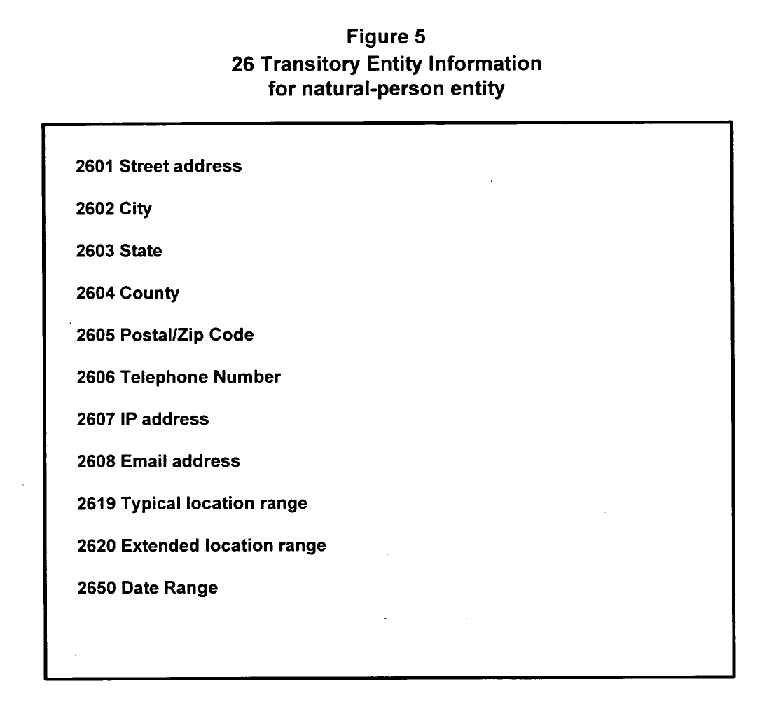

FIG. 5 is a diagram illustrating transitory entity information for a natural-person entity according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

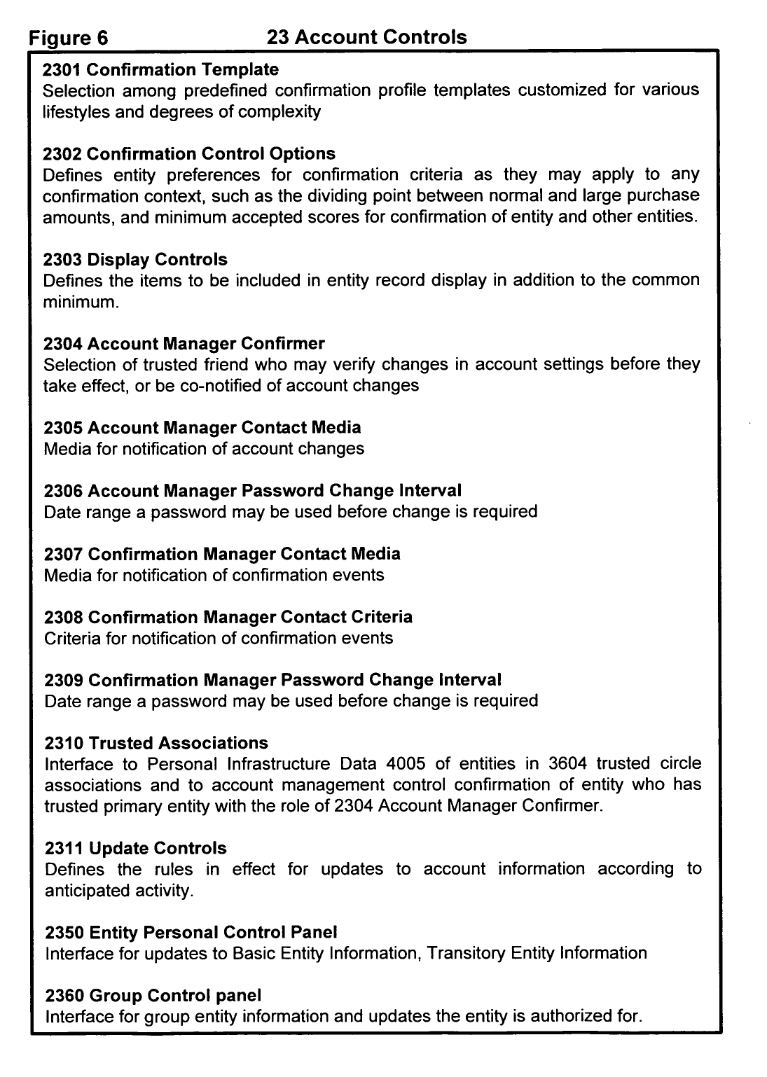

FIG. 6 is a diagram illustrating account control information according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

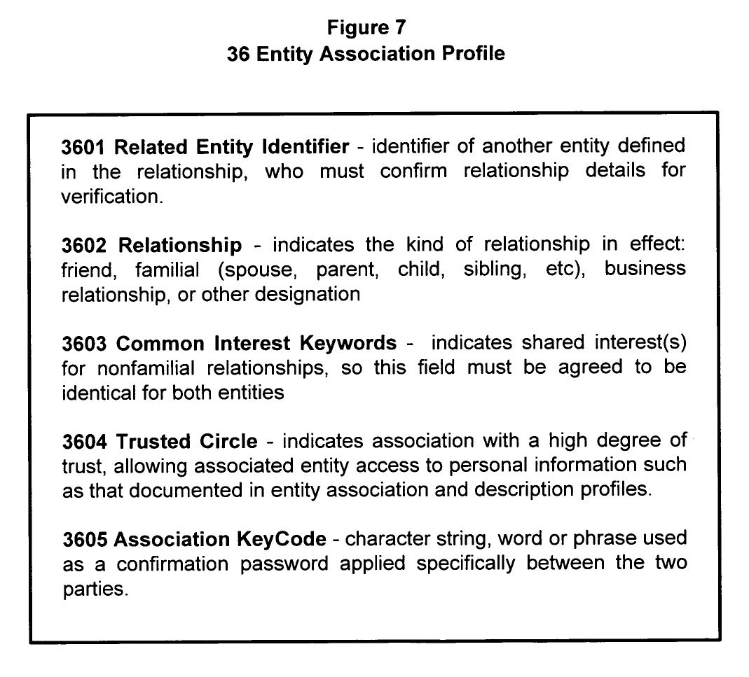

FIG. 7 is a diagram illustrating an entity association profile according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

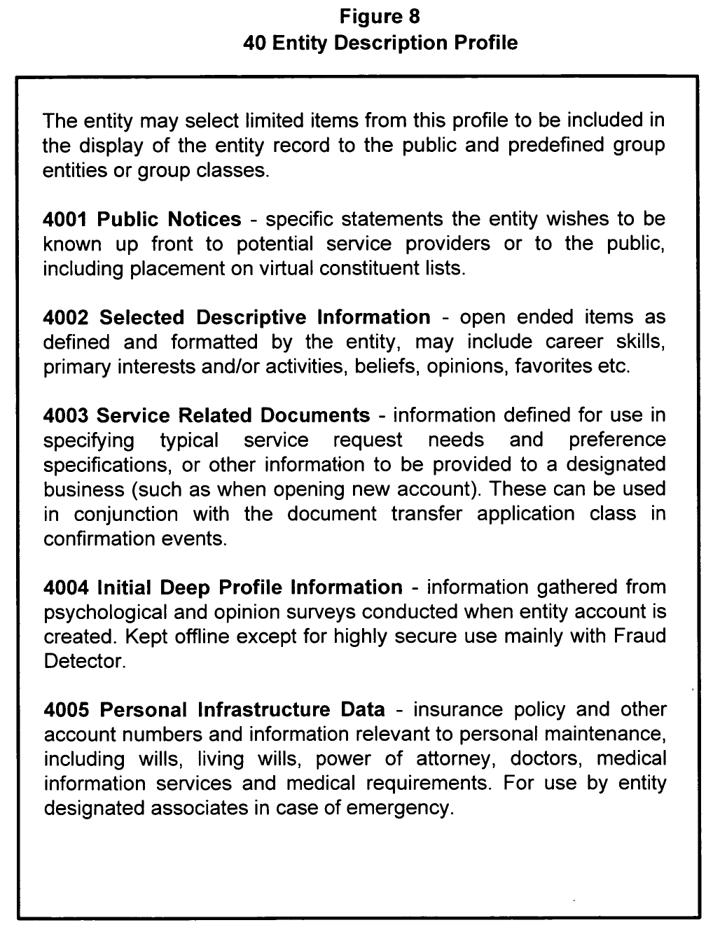

FIG. 8 is a diagram illustrating an entity description profile according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

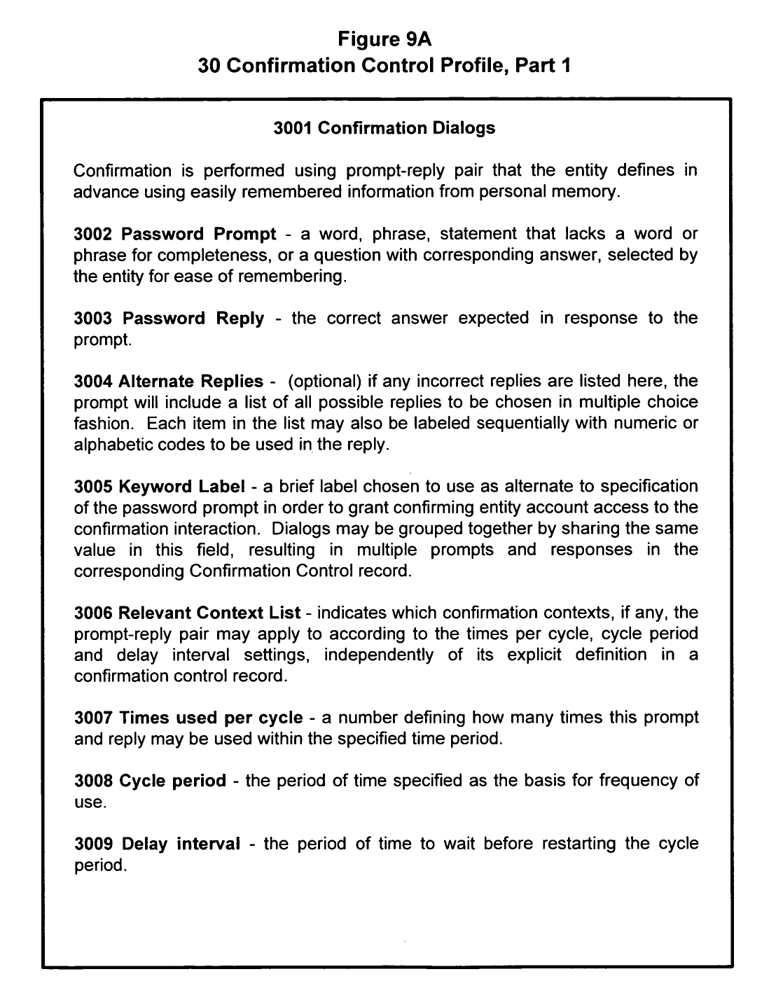

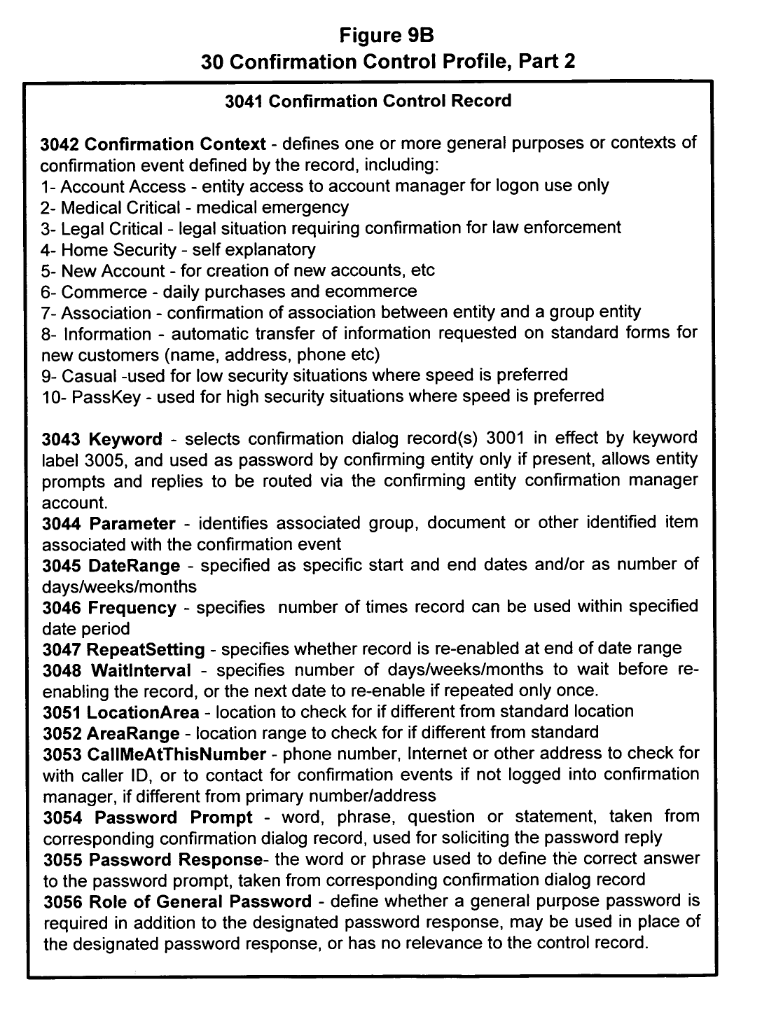

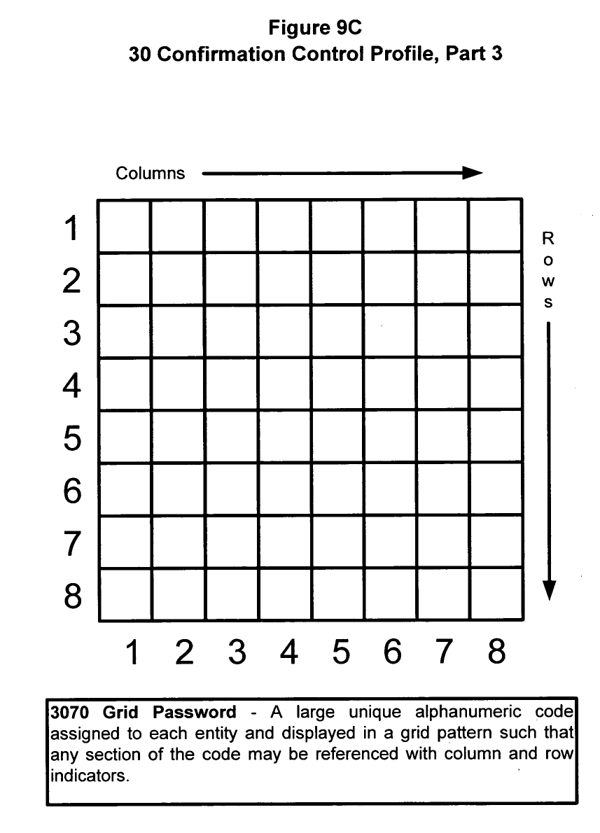

FIG. 9A is a diagram illustrating a part of a confirmation control profile according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 9B is a diagram illustrating an additional part of a confirmation control profile according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 9C is a diagram illustrating an identity code document that may be an additional part of a confirmation control profile according to an aspect of the present invention and useable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

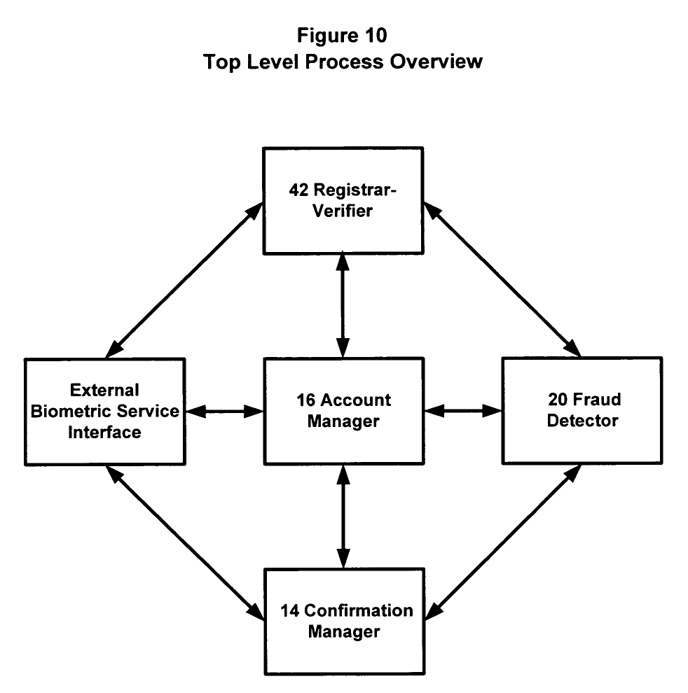

FIG. 10 is a diagram illustrating one or more communications and processes according to an aspect of the present invention and among any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

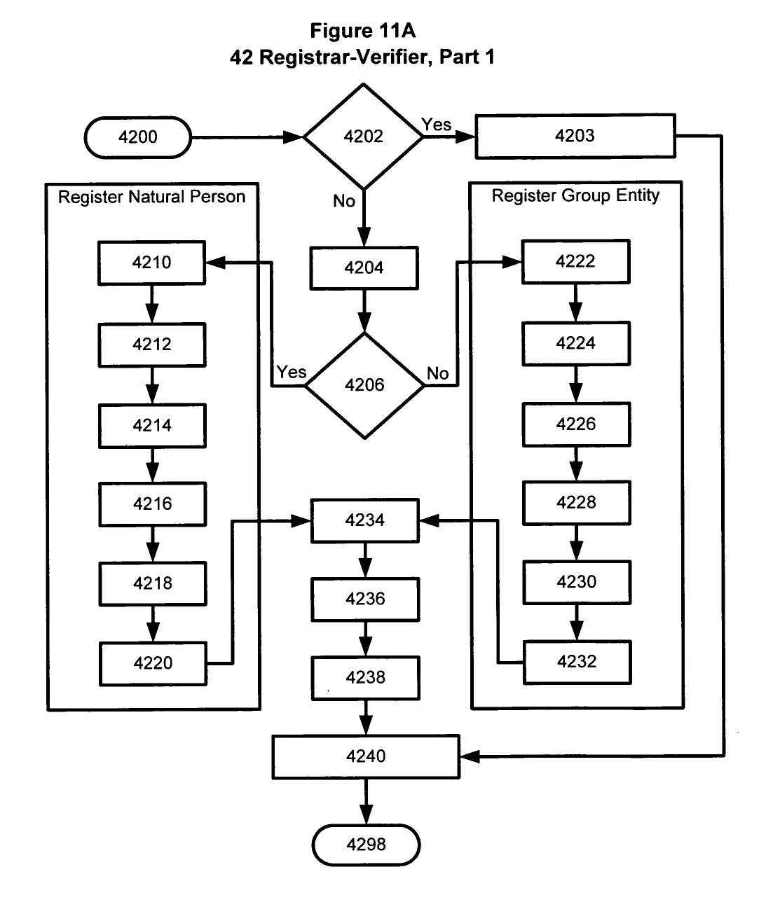

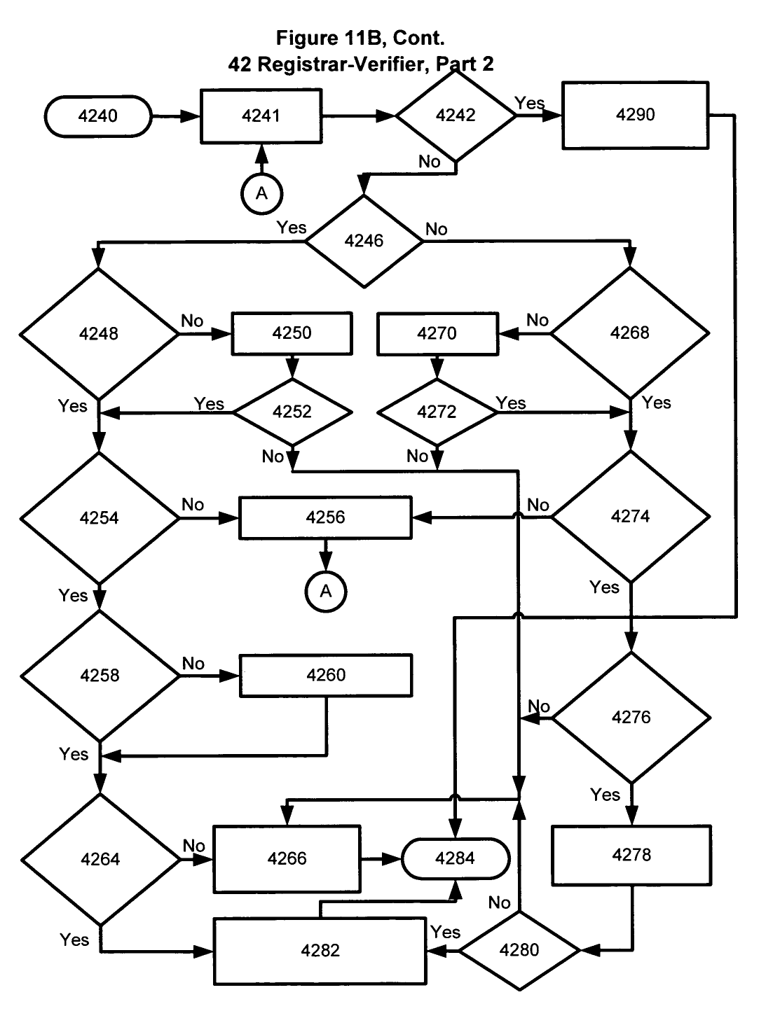

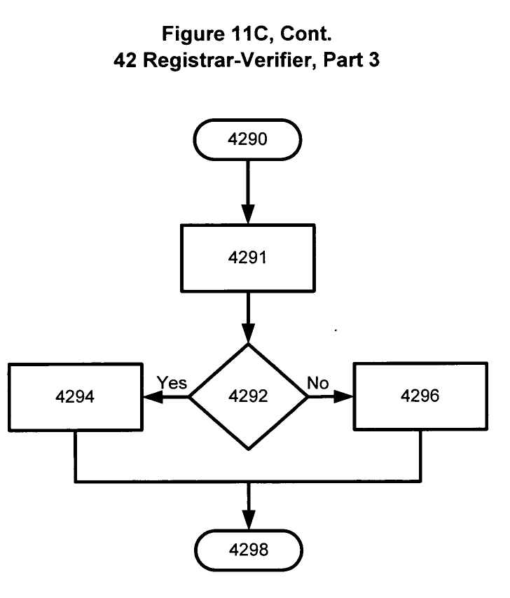

FIG. 11A is a diagram illustrating an example of a part of a registrar-verifier flow chart for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 11B is a diagram illustrating an example of an additional part of a registrar-verifier flow chart for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 11C is a diagram illustrating an example of an additional part of a registrar-verifier flow chart for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

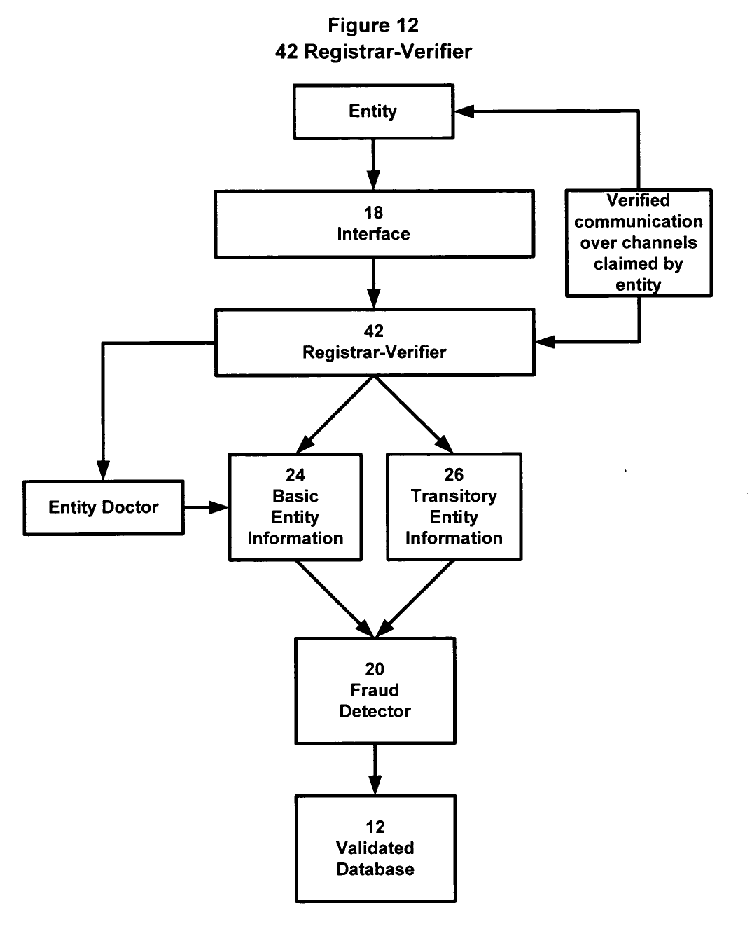

FIG. 12 is a diagram illustrating an example of a registrar-verifier data flow diagram for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

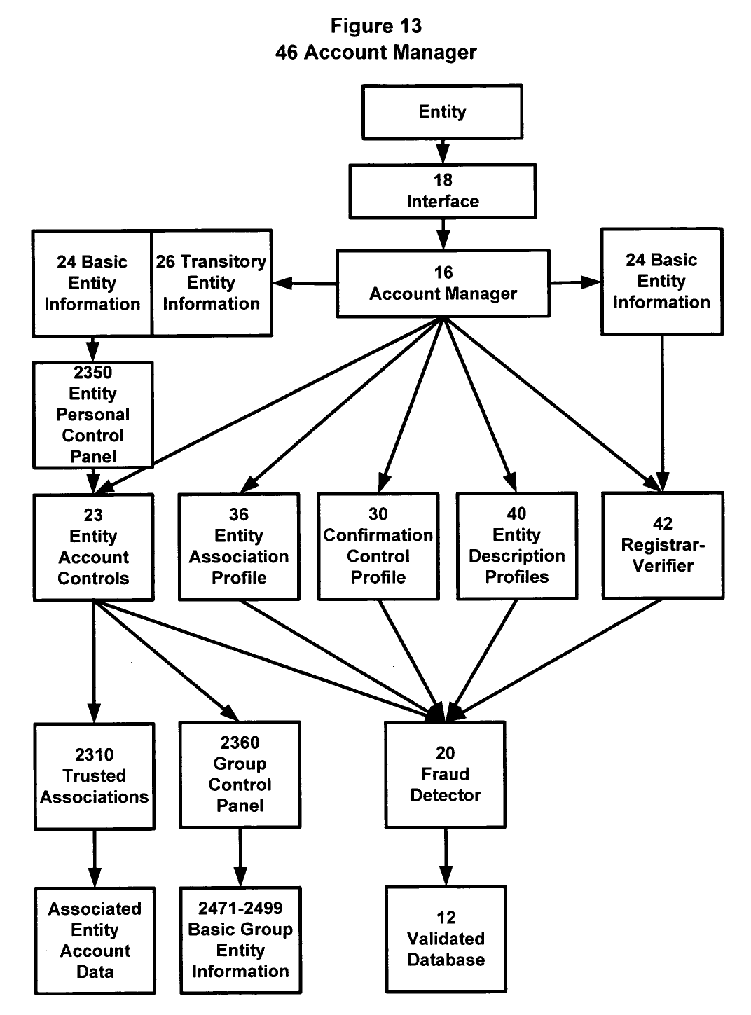

FIG. 13 is a diagram illustrating an example of an account manager data flow diagram for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

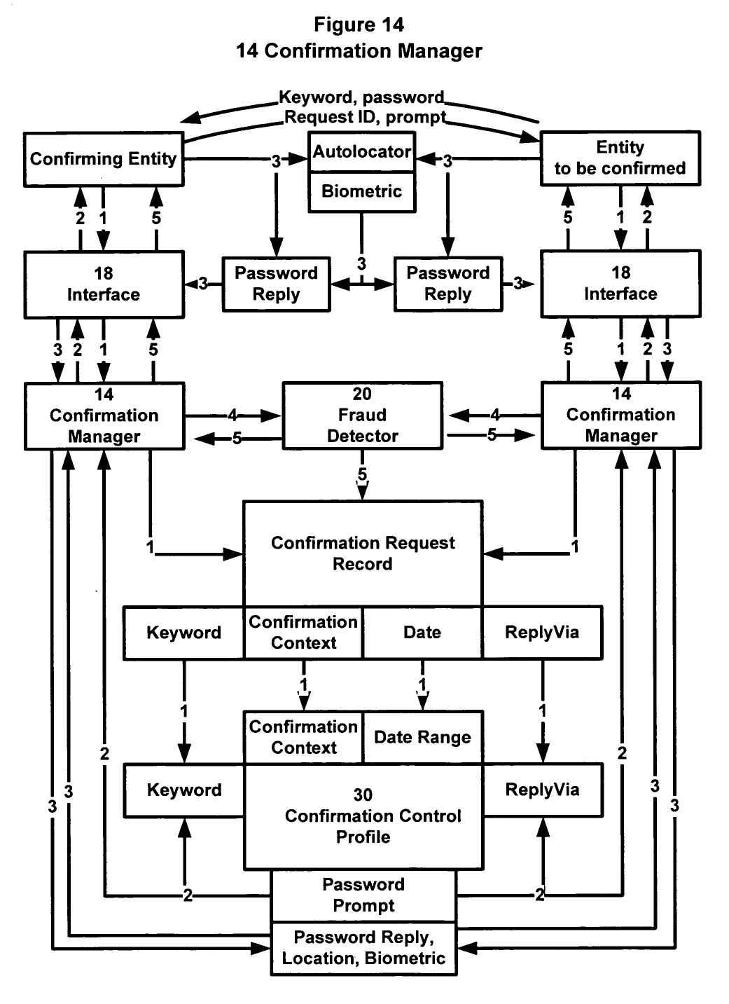

FIG. 14 is a diagram illustrating an example of a confirmation manager data flow diagram for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

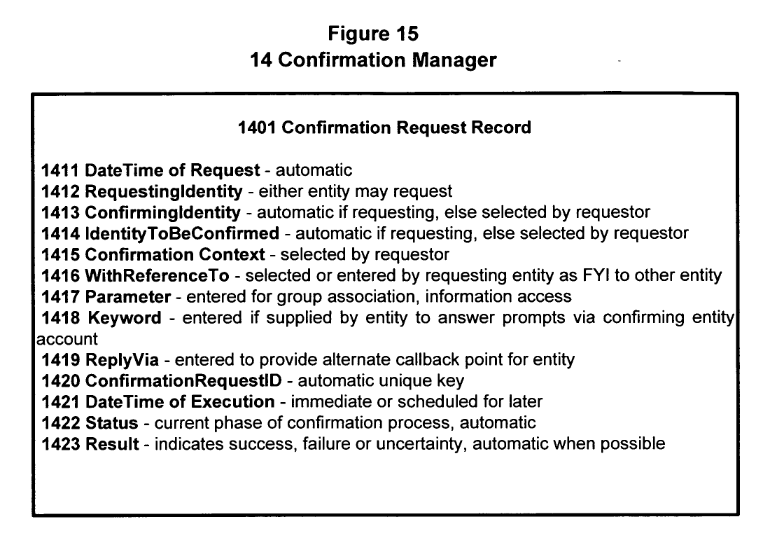

FIG. 15 is a diagram illustrating an example of a confirmation request record for an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

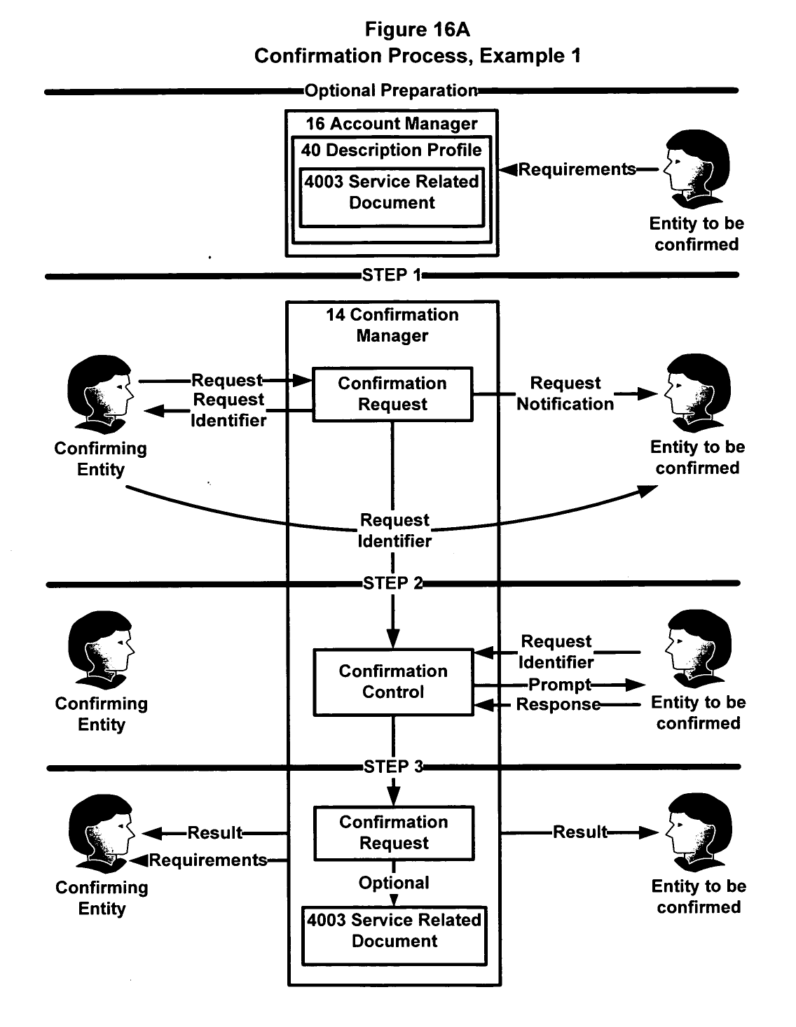

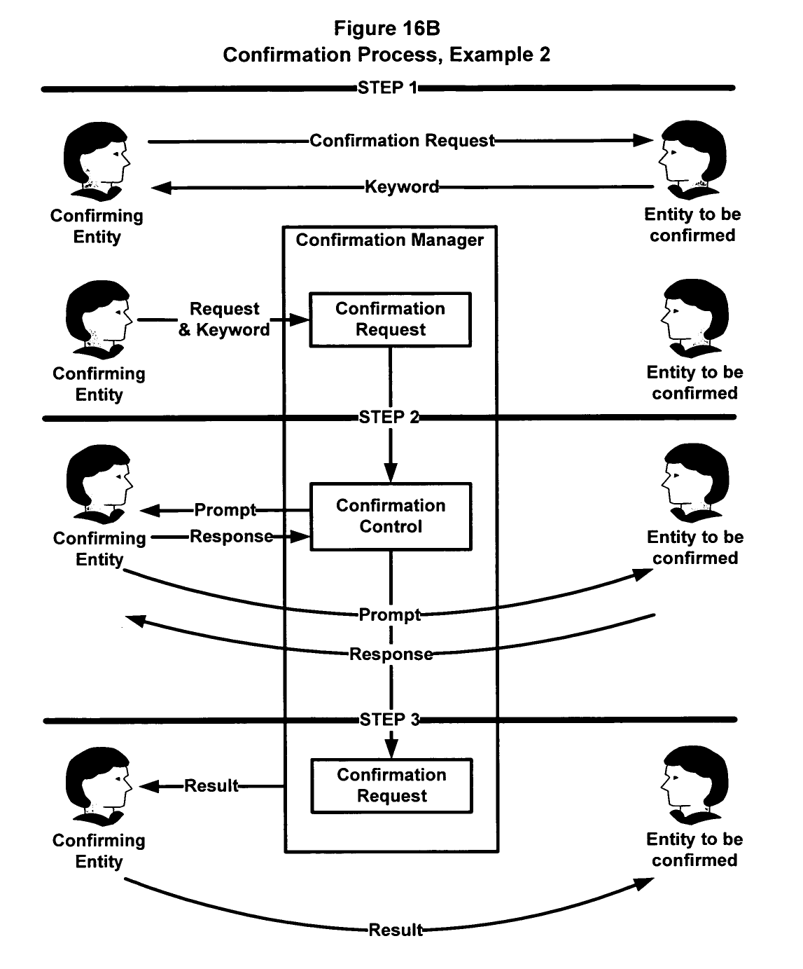

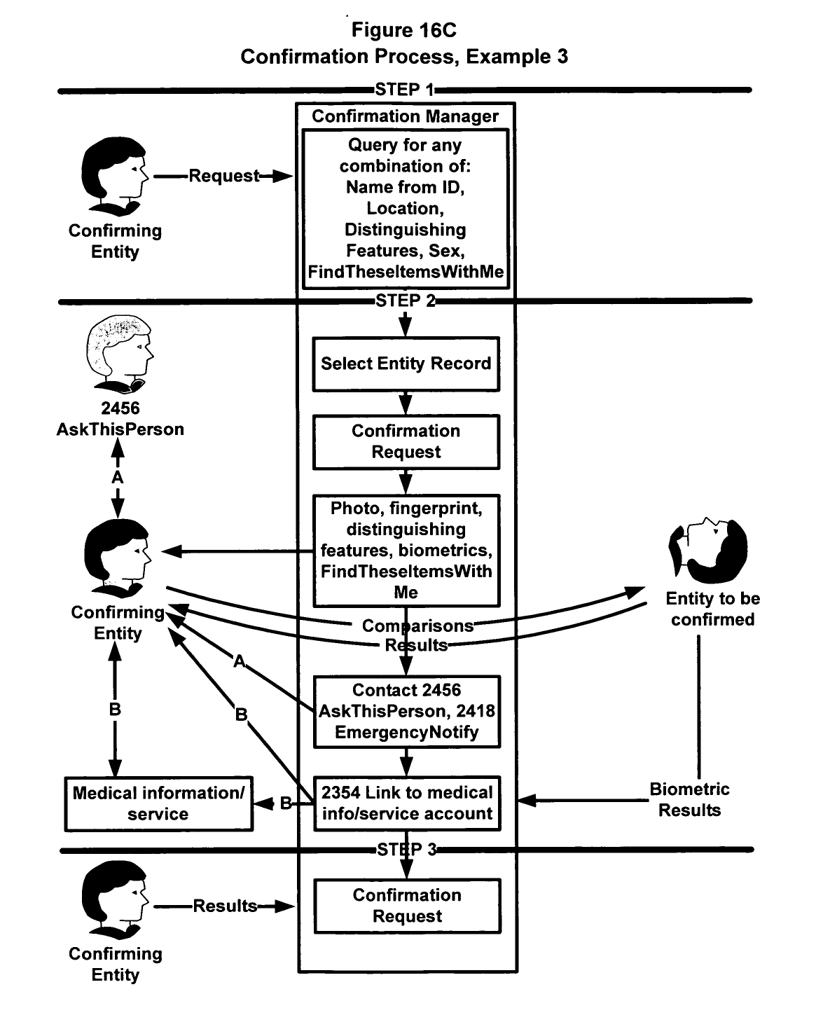

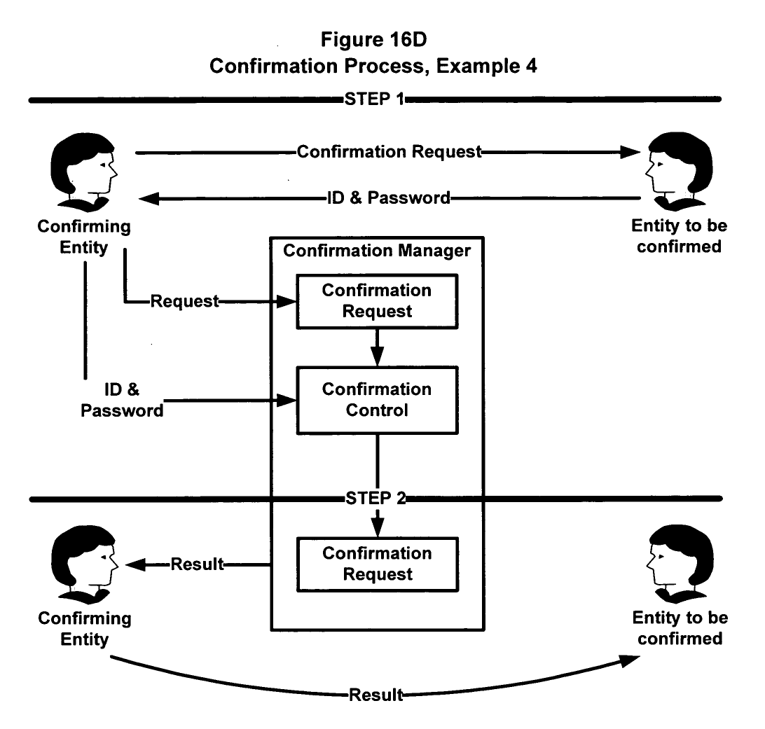

FIG. 16A is a diagram illustrating an example of a confirmation process flow of an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 16B is a diagram illustrating another example of a confirmation process flow of an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 16C is a diagram illustrating another example of a confirmation process flow of an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 16D is a diagram illustrating another example of a confirmation process flow of an aspect of a process according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

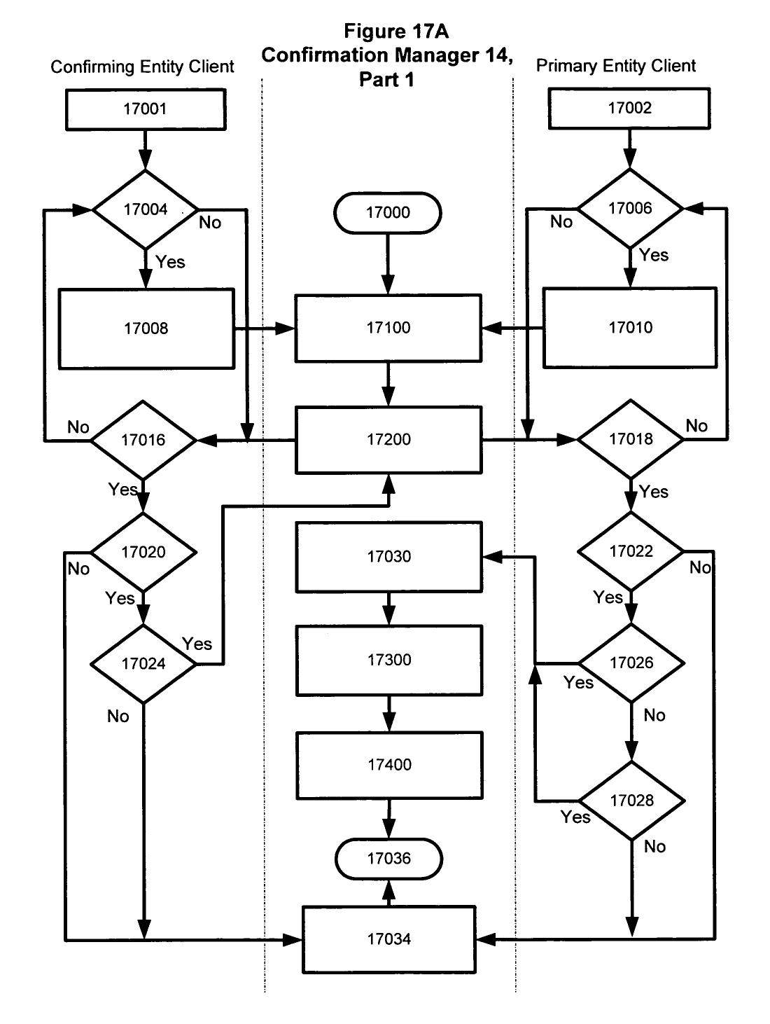

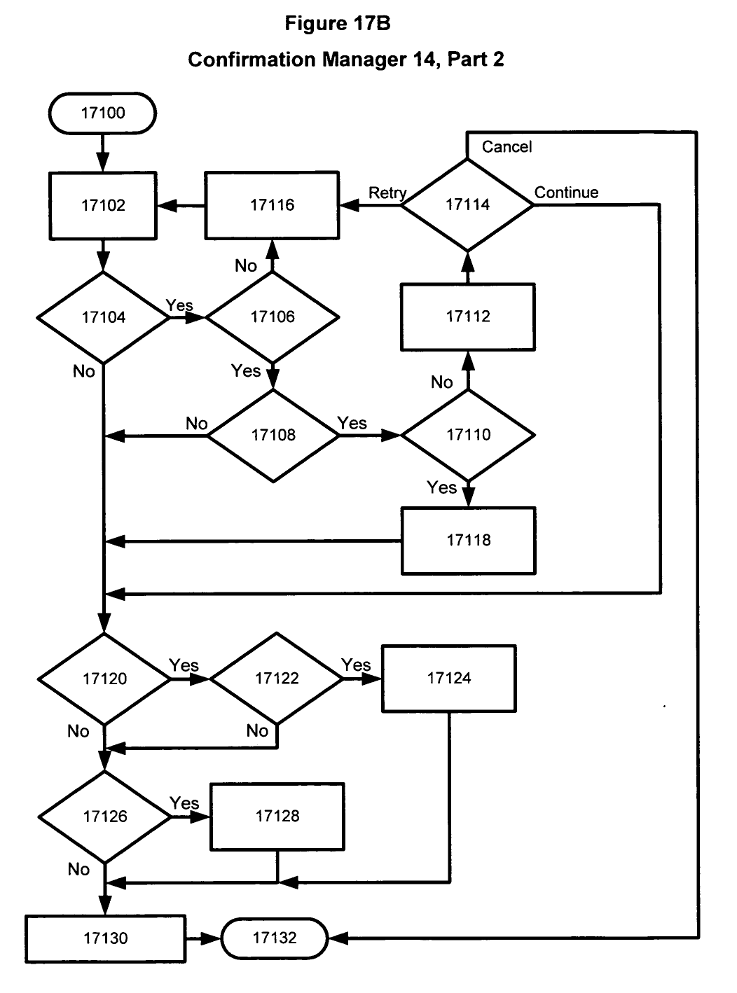

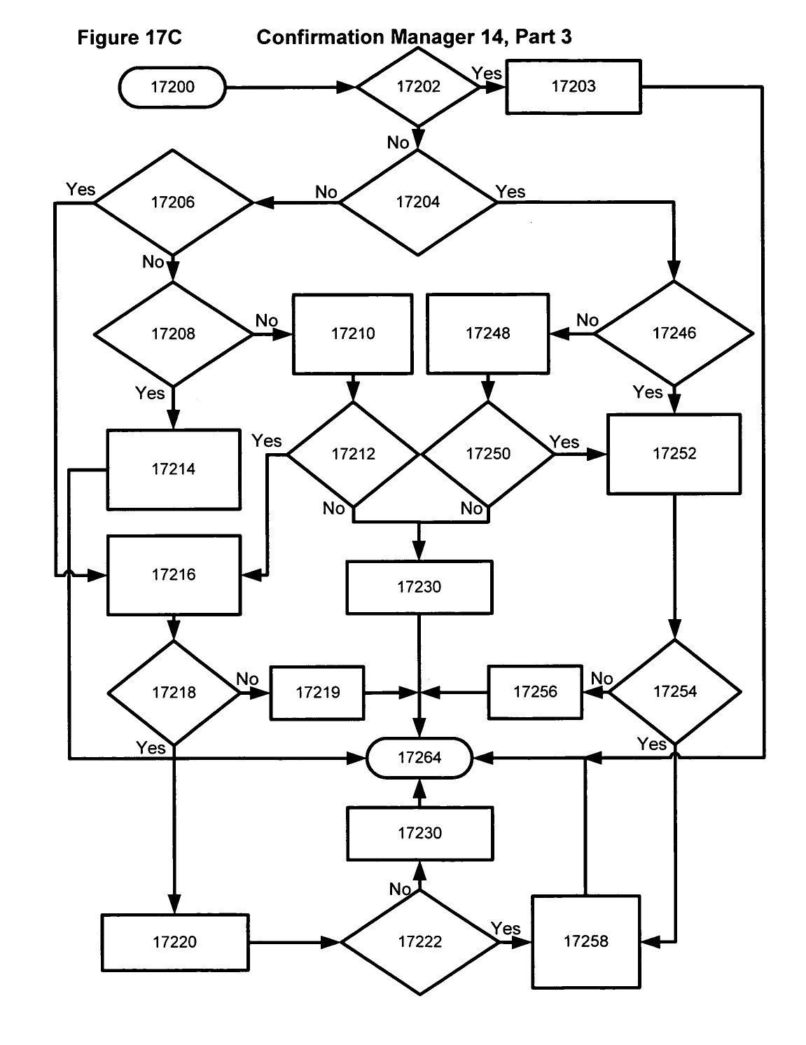

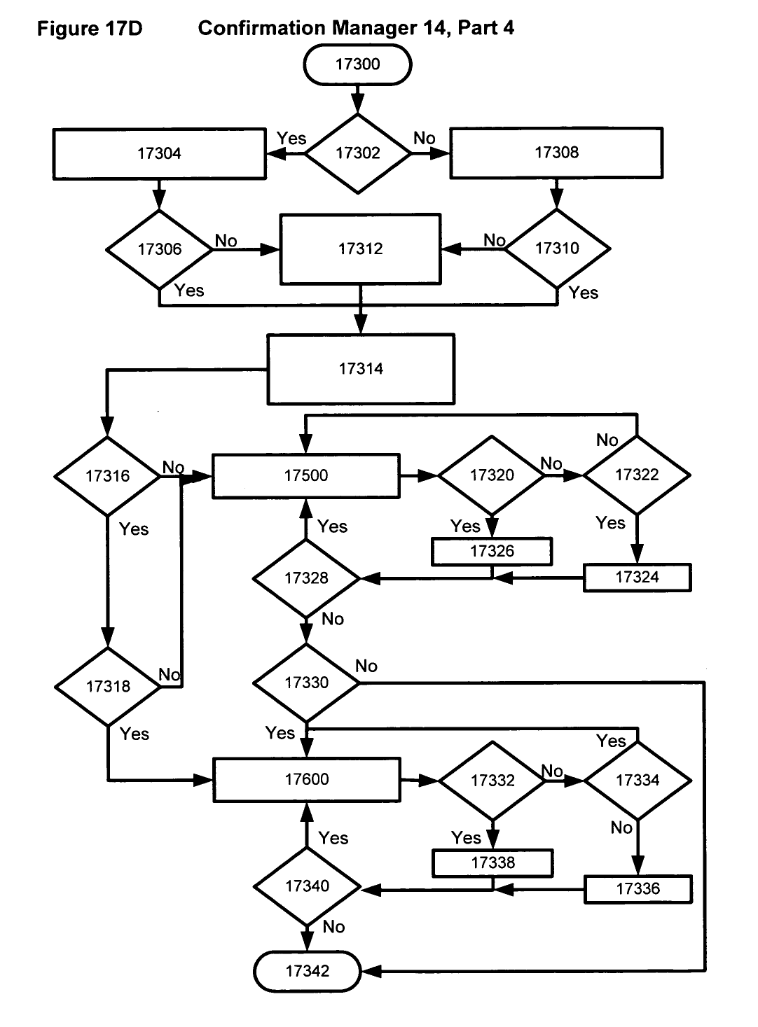

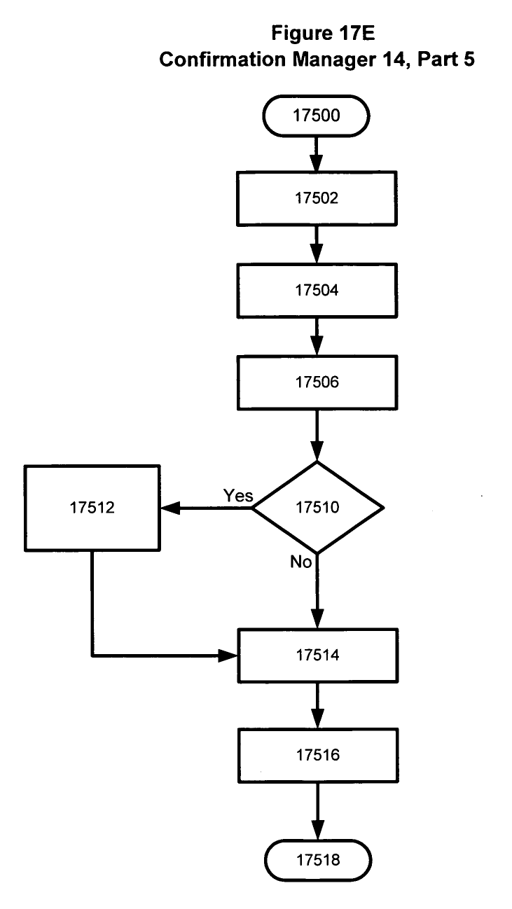

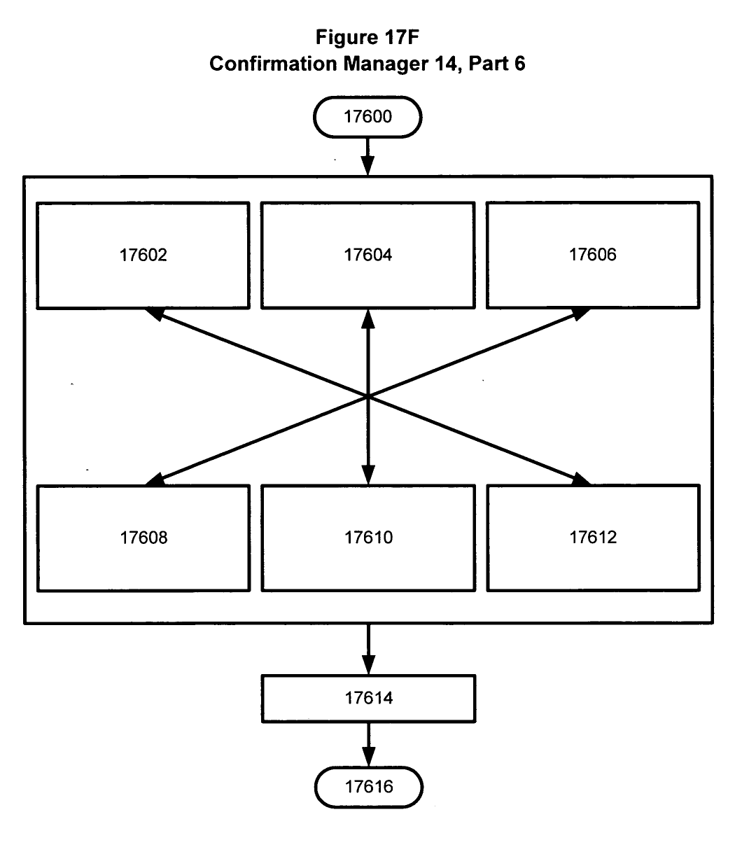

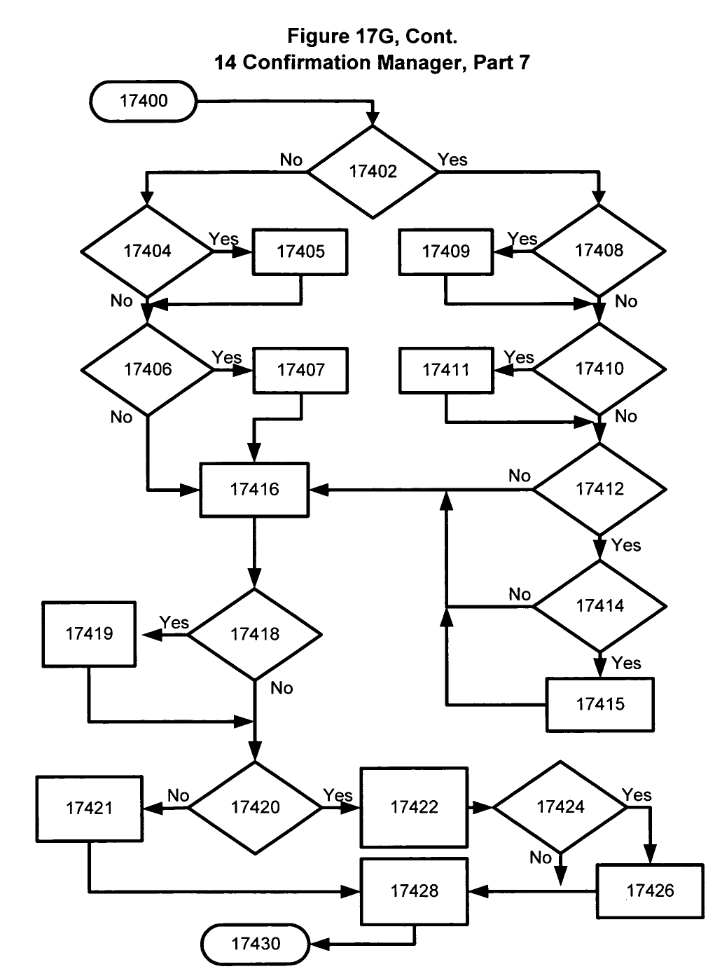

FIG. 17A is a diagram illustrating an example of a flow chart for a first part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 17B is a diagram illustrating an example of a flow chart for a second part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 17C is a diagram illustrating an example of a flow chart for a third part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 17D is a diagram illustrating an example of a flow chart for a fourth part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 17E is a diagram illustrating an example of a flow chart for a fifth part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 17F is a diagram illustrating an example of a flow chart for a sixth part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

FIG. 17G is a diagram illustrating an example of a flow chart for a seventh part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed;

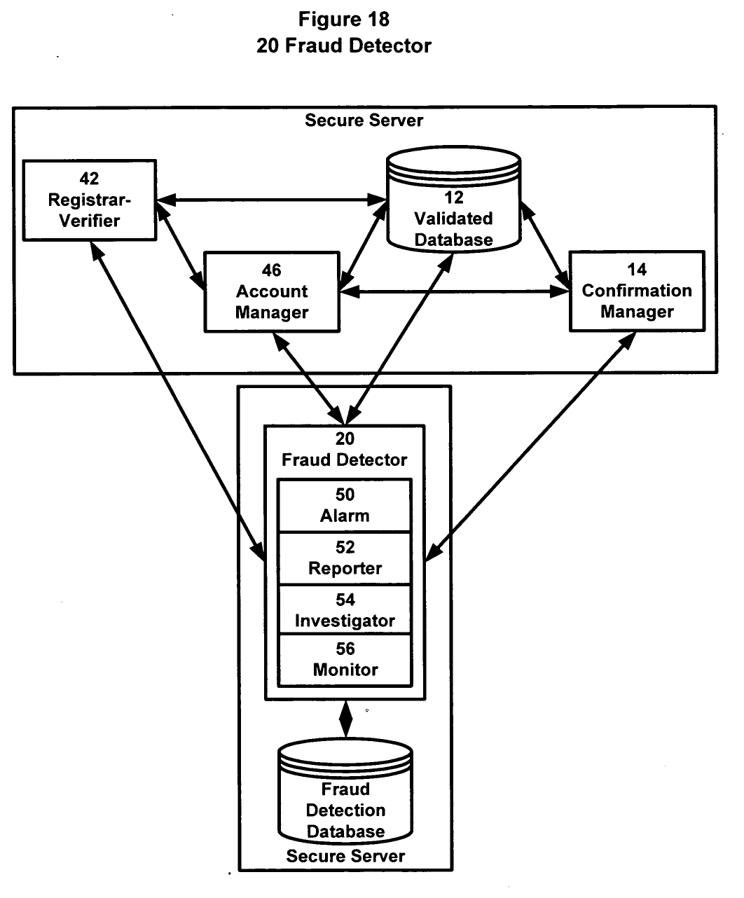

FIG. 18 is a diagram illustrating one or more communications relating to a fraud detector according to an aspect of the present invention and among any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed; and

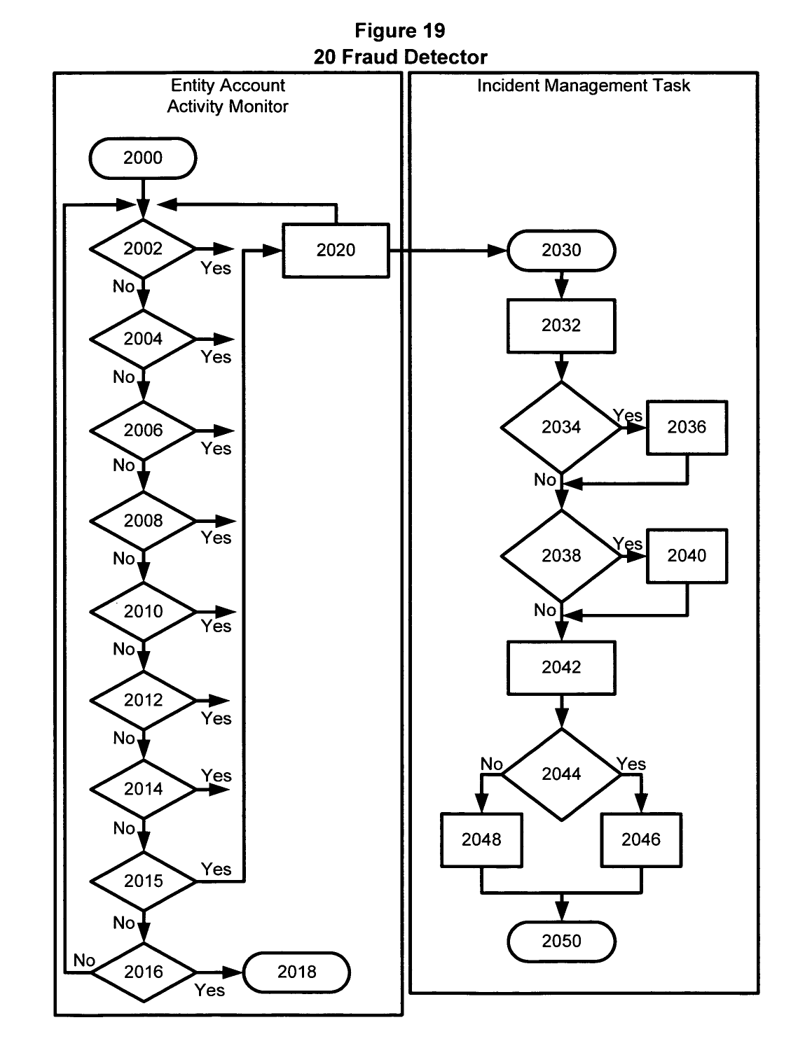

FIG. 19 is a diagram illustrating an example of a flow chart for fraud detector according to an aspect of the present invention and usable with any one of an identity management system of FIG. 1, an identity manager of FIG. 2, a validated database of FIG. 3 and/or any other aspects (whether any other aspect is taken alone or in any combination of aspects) of the present invention as may be illustrated and/or disclosed.

The present invention is directed towards a number of aspects and/or embodiments connected with an entity identity management system and/or an identity manager including, without limitation, any one of a system for managing, confirming, or managing and confirming one or more entity identities, a method for managing, confirming, or managing and confirming one or more entity identities, and/or software for effecting any combination of any of the preceding.

Applicant includes the following scenarios to provide an understanding of the present invention. It should be understood that the present invention may apply to any one of an entity identity management system, an identity manager, a method of operating an entity identity management system, a method of operating an identity manager, software for effecting an operation of an entity identity management system, software for effecting an operation of an identity manager, or any combination of the preceding and is not limited to the following scenarios.

Consider for a moment a person (an entity or an entity to be confirmed) wishing to establish, for example, a credit account with a bank or an ecommerce account with an internet online service provider. In each situation, a quick establishment of such an account with an assurance of identity security would be desirable for such a person. At the same time, the bank or online service provider (a confirming entity or a confirmation requestor), desires an assurance that the identity of the person wishing to establish such an account may be confirmed. An entity identity management system of the present invention is able to provide both the person and the bank or online service provider such an assurance. A confirmation request may be started either as a request for confirmation from the bank or online service provider (a confirming entity or a confirmation requester), or a request for confirmation from a person (an entity or an entity to be confirmed). In either case, either the person or the bank or online service provider may refuse a confirmation request. Although it may be beneficial, it is not a requirement that a confirmation request occur while each of the person and the bank or online service provider are logged onto their respective accounts in communication with a confirmation manager of an identity manager of the present invention. The person to be confirmed may have predefined a telephone number or other media address for an identity manager to use in contacting the person regarding a confirmation request. To assure that the person to be confirmed, currently communicating via the identity manager, is the same person communicating via other media being used in a transaction, the person who's identity is to be confirmed may be prompted for a confirmation request identifier issued by the identity manager and presented so far only to the bank or online service provider, who communicates that confirmation request identifier to the person via their current other mode of communication. The person may interact to reply to the prompt(s) issued by the confirmation manager and previously chosen by the person. Aspects of this scenario are illustrate in FIG. 16A.

Consider for a moment a scenario similar to the one described above except that a person (an entity or an entity to be confirmed) wishing to establish an account has either limited access to identity manager through different communications channels or may desire to have an expedited confirmation. In such scenarios, a bank or online service provider (a confirming entity or a confirmation requestor) may still request confirmation of the identity of the person (an entity or an entity to be confirmed) wishing to establish an account. Here, a person may provide the bank or online service provider a keyword that matches a relevant confirmation control. In turn and through a link or through its account interface, the bank or online service provider may facilitate access to designated portions of the person's account, including the keyword supplied by the person in the confirmation request. Now the person and the bank or online service provider may read prompts from control record to the person. The person to be confirmed may provide replies for the bank or online service provider to communicate to the confirmation manager of the identity manager. Alternatively, the person may read prompts and supply the answers directly using the bank's or online service provider's account interface. Also, biometric measurement may be taken and configured through the bank's or online service provider's account interface or over a separate channel (not shown). In the end, the confirmation manager may provide the result via the bank's or online service provider's account interface. Aspects of this scenario are illustrated in FIG. 16B.

The previous scenarios involved a participation of a person (an entity or an entity to be confirmed) as the person was able to do so. Also in the previous scenarios, either the person or the bank or online service provider had an ability to refuse a confirmation request. An aspect of an entity identity management system of the present invention is that a person's identity may be conformed even when a person is unable to participate. An optional exception may be added to the entity identity management system that would prevent a refusal for predesignated confirmation contexts such as a critical-use context. This context may include, without limitation, any one of a personal safety (e.g., law enforcement), a public safety, a medical safety (e.g., emergency), or any combination of any of the preceding. As with the previous scenarios, a confirmation of the person's identity may be accomplished with an assurance of identity security and an assurance for a confirming entity (or a confirmation requestor) that the identity of the person who's identity is to be established is accurate. Consider for a moment a policeman arriving at a scene of a bicycle accident to find an unconscious person lying next to the bicycle. Through an identity management system of the present invention, the policeman (a confirming entity or a confirmation requestor) may use an account interface to submit queries to the confirmation manager using, for example, a name and/or identifier found on the unconscious person (an entity or an entity to be confirmed), in combination with a location, a sex, any distinguishing features, accompanying items discovered with the unconscious person, or any combination of any of the preceding. Then from results of the query, the policeman may select, one at a time, an entity record, to submit a confirmation request and access a full description of a person of the entity record. The policeman compares each item of the person and the entity record, logging all results. If available, the policeman may make biometric measurements for comparison with a biometric template of entity record. Also, the policeman may contact other entities documented in the entity record by the unconscious person to assist in confirming an identity, and to provide emergency notification. Once the identity is confirmed, the policeman may access medical requirements information and contact any medical information service documented by the unconscious person. The policeman logs results of all comparisons. Aspects of this scenario are illustrate in FIG. 16C.

Yet another scenario contemplated as an aspect of the present invention follows. In this scenario face to face commerce or expedited access may be accommodated. Take for example a person ordering a glass of wine at a restaurant for consumption with a meal. One goal of such a transaction would be for the restaurant, through for example a waiter, to verify that the person ordering is old enough to legally consume alcoholic beverages. The person may possess cash or an appropriate level of credit to satisfy any cost associated with the purchase the meal including any wine. Thus, any questions of credit may be irrelevant. Through an identity management system of the present invention, the waiter (a confirming entity or a confirmation requester) may request a confirmation of identity from the person (an entity or an entity to be confirmed) ordering the glass of wine. The person may provide the waiter either a keyword that matches a relevant confirmation control or a password. Through an account interface, the waiter may accesses a confirmation manager of an identity manager of the present invention using the keyword or password supplied by the person in the confirmation request. In turn, the confirmation manager provides a result the identity of the person and, thus the person's age. The waiter informs the person and accepts or rejects the person's wine order as may be appropriate. Aspects of this scenario are illustrate in FIG. 16D.

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

Also in the following description, mention may be made of the terms “password”, “pass code”, “keyword”, or “keycode”. A password signifies or implies the highest degree of security and sensitivity. A keyword signifies or implies a more commonly used value of a low to medium degree of security and sensitivity. A pass code signifies or implies a temporary code used in communications to ensure that another person involved in the communication is the same person as was last involved in an earlier communication. A keycode applies specifically to the context of an association between entities, may serve purposes beyond those traditionally associated with a password.

Referring now to the drawings in general, and FIGS. 1 and 2 in particular, it will be understood that the illustrations are for the purpose of describing one or more aspects and/or embodiments of the invention and are not intended to limit the invention thereto. As seen in FIGS. 1 and 2, an entity identity management system, generally designated 10, is shown according to the present invention. The entity identity management system 10 includes an identity manager 11 including a validated database 12 and a confirmation manager 14. The entity identity management system 10 further may include an interface 18.

In an aspect, an interface 18 may be adapted to be accessible for use through password protection. A suitable password protection includes, without limitation, using one password and/or a plurality of passwords.

The interface 18 may be adapted as any one of a wired interface, a wireless interface, or a wired and a wireless interface. To that end, the interface 18 may be a network. Examples of a suitable network include, without limitation, any one of an intranet, an internet, a telephone network, or any combination of any of the preceding. In an aspect, the interface 18 may be adapted for communication using a secure sockets layer type protocol.

Also, an interface 18 may be adapted for communication using, without limitation, any one of a telephonic type device, a computer type device, a television type device, a relative positioning type device, or any combination of any of the preceding. Examples of a suitable telephonic device include, without limitation, any one of a facsimile device, telephone device, a screen phone device, a videophone device, a mobile phone device, a web terminal device, a web pad device, a computer device, or any combination of any of the preceding. Any suitable computer device may be adapted for, without limitation, any one of a specialized client application, a web browser, or a specialized client application and a web browser. Some examples of a suitable computer device include, without limitation, any one of a personal computer, a gaming device, or any combination of any of the preceding. Examples of a suitable personal computer include, without limitation, any one of a desktop computer, a notebook computer, or any combination of any of the preceding. Other examples of a computer type device include, without limitation, any one of a gaming type device, a personal digital assistant (PDA) type device, or a gaming type device and a personal digital assistant (PDA) type device. Without limitation, examples of devices useable, alone or in combination, in one or more aspects and/or embodiments of the present invention include those disclosed in “The Digital Consumer Technology Handbook: A Comprehensive Guide to Devices, Standards, Future Directions, and Programmable Logic Solutions,” written by Amit Dhir and published by the Reed Elsevier Group plc with a copyright date of 2004.

As shown in FIG. 1, in an aspect of the present invention a relative positioning type device may be used. Examples of a suitable relative positioning type device include, without limitation, those adapted for any one of a hyperbolic positioning type device, a trilateration type device, or a hyperbolic positioning type device and a trilateration type device. Some such device includes, without limitation, a global positioning type device.

Returning now to FIG. 2 and an identity manager 11 usable in an entity identity management system 10, an identity manager 11 includes a validated database 12 and a confirmation manager 14. The validated database 12 includes entity-controllable data 22. As a security precaution, at least a portion of the entity-controllable data 22 may be encrypted.

Turning now to FIG. 3 that shows that a validated database 12 may include, without limitation, any one of entity account controls 23, basic entity information 24, transitory entity information 26, a confirmation-control profile 30, an entity-association profile 36, an entity-description profile 40, or any combination of any of the preceding. Among the entity information 24 may be included one or more uniqueness identifier(s).

Basic entity information 24 may include, without limitation, information associated with any one of an entity that is a natural-person entity, an entity that is other than a natural-person entity (e.g., a group entity such as loosely associated natural persons and/or a legal person), or any combination of any of the preceding. In an aspect, as noted in FIGS. 4A(1), 4A(2), & 4A(3) and Table 1, the basic entity information 24 that is associated with a natural-person entity may include, without limitation, any one of a name, a sex, a city of birth, a date of birth, a mother's maiden name, a photograph of a natural-person entity, a signature of a natural-person entity, a marital status, a personalized uniqueness phrase, a nation(s) of citizenship, a primary spoken language, a secondary spoken language, a fingerprint, a driver's license number, or any combination of any of the preceding. Examples of suitable name formats include, without limitation, any one of a first name, a middle name, a last name, or any combination of any of the preceding. Sometimes a suitable name format may include a full name. Examples of a suitable format for any one of the photograph of a natural-person entity, the signature of a natural-person entity, or the photograph and the signature of a natural-person entity include, without limitation, relatively recent versions thereof (e.g., taken within the past one to three years).

TABLE 1
Examples of Basic Entity Information 24 for a natural-person entity
alone or that may be a member of a group entity

| | |
|---|---|
| Family Name 2401 | County 2434 |
| First Name 2402 | Postal/Zip Code 2435 |
| Middle Name 2403 | Telephone Number 2436 |
| Maiden Name 2404 | IP address 2437 |
| Full Name 2405 | Email address 2438 |
| Sex 2406 | Universal Resource Locator (URL) |
| | 2439 |
| Birth Date 2407 | Call Me At This Number 2440 |
| Birth State or Province&City 2408 | Typical range of location 2449 |
| Citizen of Nation(s) 2409 | Extended range of location 2450 |
| Social Security Number 2410 | Distinguishing Physical Features |
| | 2451 |
| Driver's License State or | Biometric templates 2452 |
| province&Number 2411 | |
| Primary Spoken Language 2412 | Medical Conditions and |
| | Disabilities 2453 |
| Secondary Spoken Language 2413 | Medical Information/Service |
| | Account Links 2454 |
| Signature 2414 | Find These Items With Me 2455 |
| Photograph 2415 | AskThisPerson 2456 |
| Fingerprint 2416 | GPS/Auto-Locator Account 2460 |
| Marital Status 2417 | Digital Signature 2462 |
| Emergency Notify 2418 | Race-ethnicity 2464 |
| Uniqueness Phrase chosen by entity | Hair Color 2465 |
| 2419 | |
| Legal Proxy Registered Entity 2420 | Eye Color 2466 |
| Street address 2431 | Complexion 2467 |
| City 2432 | Verification Grade 2468 |
| State or province 2433 | |

In another aspect, as noted in FIGS. 4B(1) & 4B(2) and Table 2 & 3, basic entity information 24 that is associated with a group entity (an entity that is other than a natural-person entity) may include, without limitation, any one of information associated with at least one natural-person entity that is a member of the group entity, information associated with at least one authorized natural-person entity that is a member of the group entity, a name of the group entity, a name of an entity related to the group entity, an industrial classification of the group entity, at least one aspect of an address for the group entity, a legal category for the group entity, or any combination of any of the preceding.

TABLE 2
Examples of Basic Entity Information 26 for a group entity

| | |
|---|---|
| Group Entity Name 2471 | State or province 2481 |
| Group Entity Classification 2472 | County 2482 |
| Entity Parent Name 2473 | Postal/Zip Code 2483 |
| Intermediate Parent Name 2474 | Telephone Number 2484 |
| Ultimate Parent Name 2475 | IP address 2485 |
| Industrial Classification 2476 | Email address 2486 |
| Industrial Classification 2477 | Domain Name 2487 |
| Industrial Sector 2478 | Account Controller Entity 2488 |
| Street Address 2479 | Account Controller Proxies 2489 |
| City 2480 | |

TABLE 3
Examples an internal authority structure that may be included in the
Basic Entity Information 26 for a group entity

| | |
|---|---|
| Subgroup name 2491 | List of entities authorized for |
| | control of updates to subgroup 2495 |
| Function or authority served 2492 | Minimum accepted scores for each |
| | confirmation context for group |
| | entity and other entities 2496 |
| Managing Subgroup 2493 | Authority to issue requests of a |
| | critical nature 2499 |
| List of Member entities, their | |
| respective roles and critical request | |
| authorities 2494 | |

Examples of suitable basic entity information 24 for a natural-person entity that is a member of a group entity may include, without limitation, any one of a name, a sex, a city of birth, a date of birth, a mother's maiden name, a photograph of a natural-person entity, a signature of a natural-person entity, a marital status, a personalized uniqueness phrase, a nation(s) of citizenship, a primary spoken language, a secondary spoken language, a fingerprint, a driver's license number, or any combination of any of the preceding. As with a natural-person entity, examples of suitable name formats may include, without limitation, any one of a first name, a middle name, a last name, a full name, or any combination of any of the preceding. Examples of a suitable format for any one of the photograph of a natural-person entity, the signature of a natural-person entity, or the photograph and the signature of a natural-person entity may include, without limitation, relatively recent versions thereof (e.g., taken within the past one to three years).

Examples of suitable basic entity information 24 associated with a name of a group entity may include, without limitation, any one of a fictitious business name or doing business as (dba) name, a registered name, or any combination of any of the preceding. Also, examples of suitable basic entity information 24 associated with a name of an entity related to a group entity may include, without limitation, any one of a name of a parent entity of a group entity, a name of an intermediate parent of a group entity, a name of the ultimate parent entity of a group entity, or any combination of any of the preceding.

Examples of suitable basic entity information 24 associated with an industrial classification of a group entity includes, without limitation, any one of a sector for a group entity, a standard industrial classification, the North American Industry Classification System, or any combination of any of the preceding. This basic entity information 24 associated with the sector for a group entity or the North American Industry Classification System for a group entity may include, without limitation, any one of a subsector, an industry group, an industry, a national industry, or any combination of any of the preceding. Alternatively, this basic entity information 24 associated with the standard industrial classification for a group entity may include, without limitation, any one of a division, a major group, an industry group, an industry, or any combination of any of the preceding

Examples of suitable basic entity information 24 associated with at least one aspect of an address of a group entity may include, without limitation, any one of a street name, a street number, a city, a state or province, a postal code, an internet address, a telephone address (e.g., a telephone number), a Universal Resource Locator (URL), an e-mail address, or any combination of any of the preceding.

Examples of suitable basic entity information 24 associated with at least one aspect of a legal category for a group entity may include, without limitation, any one of an association, a bank, a collective, a cooperative, a corporation, a hybrid between a corporation and a partnership, an estate, a governmental institution, a partnership, a political party, a political action committee (PAC), a union, a trust, or any combination of any of the preceding. Examples of suitable governmental institution may include, without limitation, a municipality, a state or province, a federal government, a national government, or any combination or sector of any of the preceding.

TABLE 4
Examples of Transitory Entity Information 26 for a natural-person
entity alone or that may be a member of a group entity

| | |
|---|---|
| Street address 2601 | Telephone Number 2606 |
| City 2602 | IP address 2607 |
| State or province 2603 | Email address 2608 |
| County 2604 | Typical location range 2619 |
| Postal/Zip Code 2605 | Extended location range 2620 |
| | Date Range 2650 |

As noted in FIGS. 3 & 5 and Table 4, a validated database 12 further may include transitory entity information 26. Some examples of transitory information may include, without limitation, any one of a date range, a temporary address, a primary domicile address, a secondary domicile address, a mobile phone number, a temporary location phone number, an internet address, an e-mail address, a transitory typical location range, a transitory extended location range, or any combination of any preceding. A temporary address or a primary domicile address or a secondary domicile address may include, without limitation, any one of a street address, a state or province, a city, a postal code, or any combination of any of the preceding.

As noted in FIGS. 3 and 6, a validated database 12 further may include account controls 23. Some examples of account controls 23 may include, without limitation, any one of a confirmation template 2301, confirmation control options 2302, display controls 2303, account manager confirmer 2304, account manager contact media 2305, account manager password change interval 2306, confirmation manager contact media 2307, confirmation manager contact criteria 2308, confirmation manager password change interval 2309, trusted associations 2310, update controls 2311, entity personal control panel 2350, group control panel 2360, or any combination of any of the preceding.

A confirmation template 2301 may facilitate a selection among a number of predefined confirmation profile templates that may be customizable, for example, for various lifestyles, frequencies of need and/or degrees of complexity.

A confirmation control options 2302 define natural person entity preferences for confirmation criteria as they may apply to any confirmation context, such as the dividing point between normal and large purchase amounts, and minimum accepted scores for confirmation of entity and other entities, and may facilitate a natural-person entity's selection of non-critical confirmation contexts that may be accommodated for a time period even without a corresponding confirmation control record. Display controls 2303 may define a set of items to be included in an entity record that is displayed that may be in addition to the common minimum information displayed.

An account manager confirmer 2304 may include a trusted friend who may verify changes in account settings before they take effect, or be co-notified of account changes.

Account manager contact media 2305 may include media channels for notification of account changes such as, for example, as any one of a wired interface, a wireless interface, or a wired and a wireless interface. To that end, a media channel may be an interface 18 or a part of an interface 18. In turn, media channels may include a network. Examples of a suitable network include, without limitation, any one of an intranet, an internet, a telephone network, or any combination of any of the preceding. In an aspect, a media channel may be adapted for communication using a secure sockets layer type protocol.

An account manager password change interval 2306 and/or confirmation manager password change interval 2309 may include a date range during which a password may be used before password change is requested or required.

Confirmation manager contact media 2307 may include media channels for media for notification of confirmation events such as, for example, as any one of a wired interface, a wireless interface, or a wired and a wireless interface. To that end, a media channel may be an interface 18 or a part of an interface 18. In turn, media channels may include a network. Examples of a suitable network include, without limitation, any one of an intranet, an internet, a telephone network, or any combination of any of the preceding. In an aspect, a media channel may be adapted for communication using a secure sockets layer type protocol.

Confirmation manager contact criteria 2308 may include criteria for notification of confirmation events.

Trusted associations 2310 may provide an interface to personal infrastructure documents 4005 (see e.g., FIG. 8) of an entity in trusted circle associations 3604 (see e.g., FIG. 7) and to account management control confirmation of entity who has trusted entity with the role of account manager confirmer 2304.

Update controls 2311 may define a set of rules in effect for updates to account information according to, for example, anticipated activity.

An entity personal control panel 2350 may be an interface for updating to basic entity information 24 and/or transitory entity information.

A group control panel 2360 may be an interface for a group entity and for updating to basic entity information 24 and/or transitory entity information for the group entity, a natural-person entity that is a member of the group entity, an authorized natural-person entity of the group entity, or any combination of the preceding.

As noted in FIGS. 3 and 7, a validated database 12 further may include an entity association profile 36. Some examples of entity association information may include, without limitation, any one of a related entity identifier 3601, relationship 3602, common interest keywords 3603, trusted circle 3604, association keycode 3605, or any combination of any on the preceding. A related entity identifier 3601 may include an identifier of a natural-person entity or a group entity defined in a relationship and who is capable of confirming relationship details for verification. A relationship 3602 may indicate a kind of relationship in effect, such as, for example, friend, family (spouse, parent, child, sibling, . . . etc.), professional (supervisor, client, accountants, attorney, minister, . . . etc.), business relationship (customer/provider), other designation, or any combination of any of the preceding. Common interest keywords 3603 may indicate shared interest(s) for nonfamilial relationships, so this field is agreed to be identical for both entities. A trusted circle 3604 may indicate an association with a high degree of trust, allowing an associated entity access to personal information such as that documented in an entity association profile 36 and/or an entity description profile 40. An association KeyCode 3605 may include a character string, word, phrase, or any combinations of any of the proceeding that may be used as a confirmation password applied specifically between the two entities. An association profile 36 may include, without limitation, any one of an additional entity other than the entity, an additional entity having a relationship to the entity, or any combination of any of the preceding. Examples of a suitable additional entity having a relationship to the entity may include, without limitation, any one of a friend, a family member, a spouse, or any combination of any of the preceding.

As noted in FIGS. 3 and 8, a validated database 12 further may include an entity description profile 40. Some examples of items that an entity description profile 40 may include, without limitation, are any one of public notices 4001, selected descriptive information 4002, service related documents 4003, initial deep profile information 4004, personal infrastructure data 4005, or any combination of any of the preceding. An entity may select items from this profile to be included in a display of an entity record to the public and/or a predefined group entity and/or group classes. Public notices 4001 may include one or more specific statements that an entity wishes to be known up front to potential service providers and/or to the public, including placement on virtual constituent and preference lists. Selected descriptive information 4002 may include open ended items as defined and formatted by an entity such as, for example, career skills, primary interests and/or activities, beliefs, opinions, favorites, . . . etc. Service related documents 4003 may include information for use in specifying typical service request needs and preference specifications, or other information to be provided to a designated business (such as when opening new account) and may be used in conjunction with a confirmation context that accommodates document transfer in confirmation events. Initial deep profile information 4004 may include information gathered from psychological and opinion surveys conducted when entity account is created (such information is kept offline except for highly secure use such as with a fraud detector 20). Personal infrastructure data 4005 may include information about insurance policy and other account numbers and information relevant to personal maintenance, including wills, living wills, power of attorney, doctors, medical information services and medical requirements and may be used by an entity designated associate in case of an emergency. Also, an entity description profile 40 may include, without limitation, at least one notice from or for the public record concerning the entity.

As noted in FIGS. 3, 9A, 9B, and 9C, a validated database 12 further may include a confirmation-control profile 30. In an aspect, a confirmation-control profile 30 may include a characteristic commensurate with an associated confirmation context. Examples of suitable associated confirmation context may include, without limitation, any one of a critical-use context, semi-critical-use context, a non-critical-use context, or any combination of any of the preceding. A critical-use confirmation context may include, without limitation, any one of a personal safety, a public safety, a medical safety (emergency), or any combination of any of the preceding further includes at least one controlled-access personal detail. An at least one controlled-access personal detail may include, without limitation, any one of an entity to notify in case of emergency (EmergencyNotify), an entity to check with for assistance in determining identity (AskThisPerson), a physical feature usable to confirm the entity's identity (DistinguishingPhysicalFeatures), an item carried by the entity and usable to confirm the entity's identity (FindTheseItemsWithMe), or any combination of any of the preceding. Examples of a physical feature usable to confirm the entity's identity may include, without limitation, a private physical feature (DistinguishingPhysicalFeatures).

Semi-critical-use class or the non-critical-use confirmation contexts may be adapted to accommodate a variety of, without limitation, any one of frequencies of use, degrees of sensitivity of information used in a confirmation process, quantities of purchase or credit, associations of a natural-person entity with a group entity, transmissions of information to a confirming entity (or confirmation requestor) once an identity is confirmed, uses for home security access, confirmations allowing a confirming entity (or confirmation requestor) to rapidly check a password given by an entity, or any combination of any of the preceding.

Also in an aspect, a confirmation-control profile 30 further may include, without limitation, a keyword per record assignable by an entity so as to accommodate a controlled execution through a confirming entity (or confirmation requestor) account. In another aspect, a confirmation-control profile 30 further may include, without limitation, a date range (DateRange) assignable by an entity so as to accommodate a controlled execution. In yet another aspect, a confirmation-control profile 30 further may include, without limitation, any one of a location (LocationArea), location range (AreaRange), or any combination of any of the preceding, each assignable by an entity so as to accommodate a controlled execution.

Returning now to FIGS. 9A and 9B, 9C that show some examples of items that a confirmation-control profile 30 may include are, without limitation, any one of confirmation dialogs 3001, confirmation-control record 3041, a unique grid password 3070, or any combination of the preceding.

A confirmation may be performed using one or more prompt-reply pairs that an entity provides in advance using easily remembered information from personal memory. Some examples of items that a confirmation dialog 3001 may include are, without limitation, any one of a password prompt 3002, a password reply 3003, one or more alternate replies 3004, a keyword label 3005, a relevant confirmation context list 3006, a times used per cycle parameter 3007, a cycle period 3008, a delay interval 3009, or any combination of any of the preceding. A password prompt 3002 may be, without limitation, any one of a word, phrase, a statement that lacks a word or phrase for completeness, a question with corresponding answer, or an combination of an of the preceding that are selected by the entity for ease of remembering. In turn, a password reply 3003 may be one or more answers offered or expected in response to a password prompt 3002.

As an optional feature, one or more alternate replies 3004 may be provided such that an entity is offered the prompt in multiple choice fashion complete with a list of possible answers, such that the entity may reply with either the actual value of the correct answer, or with the numeric or alphabetic sequence code assigned to the selected choice.

A keyword label 3005 may be a brief label chosen for use as an alternate to specification of the password prompt in order to grant account access to a confirming entity during a confirmation interaction. Dialogs may be grouped together by sharing the same value in this field, resulting in multiple prompts and responses in the corresponding confirmation-control record 3041.

A relevant context list 3006 may indicate to which confirmation contexts, if any, the prompt-reply pair may apply according to the times used per cycle parameter 3007, cycle period 3008 and delay interval 3009 settings, independently of its explicit definition in a confirmation-control record 3041. A times used per cycle parameter 3007 may be a number specifying how many times this prompt and reply may be used within the specified time period. A cycle period 3008 may be a period of time specified as the basis for frequency of use. A delay interval 3009 may be a period of time to wait before restarting the cycle period.

Some examples of items that a confirmation-control record 3041 may include are, without limitation, any one of a confirmation context 3042, a keyword 3043, a parameter 3044, date range 3045, frequency 3046, repeat setting 3047, wait interval 3048, location area 3051, area range 3052, call me at this number 3053, password prompt 3054, password response 3055, role of general password 3056, or any combination of the preceding.

A confirmation context 3042 may be one or more general purposes or contexts of a confirmation event provided in a record and, without limitation, include any one of:
1-Account Access—(e.g., entity access to account manager for logon use);
2-Medical Critical—(e.g., medical emergency);
3-Legal Critical—(e.g., legal situation involving confirmation for law enforcement);
4-Home Security—(e.g., self explanatory);
5-New Account—(e.g., for creation of new accounts involving large sums, etc);
6-Commerce—(e.g., daily purchases and ecommerce);
7-Association—(e.g., confirmation of association between a natural-person entity and a group entity);
8-Information—(e.g., automatic transfer of information requested on standard forms for new customers (name, address, phone etc) or information describing entity needs, requirements, or preferences);
9-Casual—(e.g., used for low security situations where rapid confirmation is preferred, grants easy access to confirmation exchange via confirmation requestor's account);
10-PassKey—(e.g., used for high security situations where rapid confirmation is preferred); or
   any combination of any of the proceeding.

A keyword 3043 may be a password used to allow an entity to receive confirmation prompts from and send confirmation replies to a confirmation manager 14 through a confirming entity's account interface. A parameter 3044 may be used to identify an associated group, document or other identified item associated with the confirmation event. A daterange 3045 may be specified as specific start and end dates and/or as a number of days/weeks/months. A frequency 3046 may be used to specify a number of times a record may be used within specified date period. A repeatsetting 3047 may be used to specify whether record is re-enabled at end of date range. A waitlnterval 3048 may be used to specify a number of days/weeks/months to wait before re-enabling a record, or the next date to re-enable a record if repeated only once. A locationarea 3051 may be used to specify a detected location and to check if that location is different from a standard location. An arearange 3052 may be used to specify a location range and to check if that location is different from a standard location. A callmeatthisnumber 3053 may be any one of a phone number, an internet address, mailing address, other address, or any combination of the preceding (they may be different from a primary number/address) to be checked with by a confirmation manager 14 using, for example, caller ID or means that are used to contact an entity for a confirmation event when the entity is not logged into confirmation manager 14. A password prompt 3054 may be any one of a word, a phrase, a question, a statement, or any combination of the preceding the may be used as the basis for the password response 3055, designed by entity for ease of remembrance. In turn, a password response 3055 may be any one of a word or a phrase that may be used to provide an answer to the password prompt 3054. A role of general password 3056 may be defined as any one of being required in addition to a password response 3055; being sufficient used in place of the designated password response 3055; having no relevance to the confirmation-control record 3041.

Turning now to FIG. 9C, an entity may be supplied a card or small hardcopy identity code document with a checkerboard style grid with any number of columns and any number of rows containing a random, unique assortment of digits and/or characters, one digit or character per column and row combination. The checkerboard style grid may be used as a master reference such that column and row positions may be used to indicate or request passwords relevant to a specific document holder at any point in time.

In an aspect, entity-controllable data 22 further may include, without limitation, an entity-controllable criterion usable for confirmation. Examples of a suitable entity-controllable criterion may include, without limitation, any one of at least one entity specified prompt and an associated reply, a location having an area range relating to a primary address, a location having an area range relating to a transitory address, a location having an area range relating to a confirmation control, a location having an area range capable of being verified using a relative positioning type device, a confirmation context, or any combination of any of the preceding. An example of a relative positioning type device may include, without limitation, a GPS type device.

In an aspect, an identity manager 11 further may include a link usable in confirming an entity's identity and usable for obtaining data capable of assisting in resolving an issue relating to the entity's situation. As one nonlimiting example, a link may be usable for obtaining health data capable of assisting in resolving a health issue involving the entity (2454 Medical Information/Service Account Links). As another nonlimiting example, a link may be usable for obtaining data capable of assisting in resolving a safety issue involving the entity.

In an aspect and as shown in FIGS. 1, 2, and 10, an identity manager 11 further may include or have access to at least one biometric parameter 34. For example, at least one biometric parameter 34 may reside in, without limitation, any one of the validated database 12, an additional database within the identity manager 11, an additional database without the identity manager 11 and with which the identity manager 11 is adapted to communicate, or any combination of any of the preceding. Examples of suitable at least one biometric parameter 34 may include, without limitation, any one of a physiological characteristic, a behavioral characteristic, or any combination of any of the preceding. Examples of a suitable physiological characteristic may include, without limitation, a characteristic of any one of an iris, a fingerprint (including nail), a hand (including knuckle, palm, vascular), a face, a voice, a retina, a DNA, an odor, an earlobe, a sweat pore, a lip, or any combination of any of the preceding. Examples of a behavioral characteristic may include, without limitation, any one of a signature, a keystroke, a voice, a gait, or any combination of any of the preceding.

An entity identity management system 10 further may include an account-control confirmer. Stated differently, an account-control confirmer may use an identity manager 11 to assist an entity. Examples of a suitable account-control confirmer may include, without limitation, a registered and/or confirmed entity other than the entity whose identity is being confirmed. Among such an entity may be included, without limitation, any one of a spouse, a friend, or any combination of any of the preceding.

Returning to FIG. 2, a confirmation manager 14, in one or more aspects, may include, without limitation, any one of a password access, an identity confirmation protocol, a confirmation request capable of being initiated by any one of an entity, a confirmer, or an entity and confirmer, a non-critical request confirmation request capable of being refused by an entity, a confirmer, or an entity and confirmer, a request log, a system capable of contacting an entity to assure an initiation of an authorized confirmation, a system capable of using a caller ID to assure an initiation of an authorized confirmation, a confirmation context verifier capable of verifying that a specified confirmation context in a request matches that of a control record defined by the entity, a request ID suppliable by a confirming entity (or confirmation requestor) and for facilitating a communication between the confirming entity (or confirmation requester) and an entity, a password prompt, a test suppliable by a confirming entity (or confirmation requestor) and for carrying out by an entity, a geographical location comparer, an access prompt for facilitating a reply by an entity through a confirming entity's account or confirmation requestor's account, or any combination of any of the preceding.

Examples of a suitable request log may include, without limitation, any one of an identity of a requestor, an identity of an entity to be confirmed, an identity of a confirming entity (or confirmation requestor), a date and time of a request, a confirmation context of a request, a keyword provided by an entity to be confirmed, a parameter provided for specific purposes, a notifier for notifying an entity to be confirmed of the purpose of a request (withreferenceto), an alternate callback number for entity to be confirmed to access confirmation manager 14, a request status indicator, a request result, a final request result, or any combination of any of the preceding. Information for a request log may include information from one or more confirmation-request records 1401 as shown in FIG. 15 and/or the one or more confirmation-request records 1401.

As shown in FIG. 15, a confirmation-request record 1401 may include, without limitation, any one of datetime of request 1411, requestingidentity 1412, confirmingldentity 1413, identitytobeconfirmed 1414, confirmation context 1415, withreferenceto 1416, parameter 1417, keyword 1418, replyvia 1419, confirmationrequestID 1420, datetime of execution 1421, status 1422, result 1423, or any combination of any of the preceding. Datetime of request 1411 may an automatic date/time stamp placed on a confirmation-request record 1401. Requestingidentity 1412 may be a record of which entity initiated the identity confirmation request (e.g., natural-person entity or confirming entity). Confirmingidentity 1413 may be an automatic or a requestor supplied identity stamp placed on a confirmation-request record 1401 that includes a record of which entity requested the identity confirmation. Identitytobeconfirmed 1414 may be an automatic or a requestor supplied identity placed on a confirmation-request record 1401 that includes a record of which entity's identity is to be confirmed. Confirmation context 1415 may be requestor supplied to include a record of the context of the entity's identity confirmation. Withreferenceto 1416 may be requestor selected or supplied to include a FYI for the entity who's identity is to be confirmed. A parameter 1417 may be entered for group association and/or information access. A keyword 1418 may be entered, if supplied by an entity, to allow an entity to answer prompts via a confirming entity (or confirmation requestor) account. Replyvia 1419 may be available to provide alternate callback point for an entity. ConfirmationrequestID 1420 may be an automatic unique key placed on a confirmation-request record 1401. Datetime of execution 1421 may be immediate or scheduled for later. Status 1422 may be a current phase of confirmation process and may be performed automatically. Result 1423 may indicate success, failure or uncertainty and may be performed automatically.

Returning to FIG. 2, and turning to FIG. 10, that show that an identity manager 11 may include, without limitation, any one of an account manger 16, a registrar-verifier 42, a confirmation manager 14, a fraud detector 20, or any combination of any of the preceding. In an aspect, a an identity manager 11, alone or though any one of an account manger 16, a registrar-verifier 42, a confirmation manager 14, a fraud detector 20, or any combination of any of the preceding, may be adapted to be capable of any one of setting controls for one or more prespecified contexts; setting controls for one or more prespecified frequencies of use; monitoring an entity defined password prompt and a reply for a confirmation context; granting law or medical personnel access to information of a more private nature so as to assist in situation relating to any one of personal safety, public safety, medical safety (emergency), monitoring an entity defined date range limitation, monitoring an entity defined keyword for allowing an entity access through a confirming entity (or confirmation requestor) account, or any combination of any of the preceding. In an aspect, a registrar-verifier 42 may be adapted to be capable of any one of accessing the validated database 12 having the entity-controllable data 22, verifying the validated database 12 having the entity-controllable data 22, indicating a status of one or more items of information of the validated database 12 having the entity-controllable data 22, or any combination of any of the preceding.

Turning to FIG. 18 that shows that a fraud detector 20 further may include or be adapted to be capable of, without limitation, any one of an alarm 50; a reporter 52; an investigator 54; a monitor 56 monitoring activities of any one of an account manager 16; a confirmation manager 14; or any combination of any of the preceding; reporting a suspicious activity related to any one of an account manager 16; a confirmation manager 14; or any combination of any of the preceding; notifying an entity that a suspicious activity has been detected; investigating for the source of an attempt confirmed to be fraudulent, suspending an entity account when suspicious activity is detected; re-enabling an entity account upon a resolution of a suspicion, determining when a keyword has become too common; notifying an entity that a keyword has become too common, or any combination of any of the preceding. Examples of a suspicious activity may include, without limitation, any one of an attempt by two or more entities to claim a unique identifier that is the same (e.g., such as Social Security or DL (driver's license) number, fingerprint, or other unit metric); attempt to use information that proves untrue upon independent confirmation; a use of the identity manager 11 in a way contrary to a historical behavior pattern; a use of the identity manager 11 in a way contrary to an explicit instruction from the entity upon registration; an attempted access outside of a date range specified by an entity; a repeated failure to successfully confirm an identity; a cookie mismatch using web interface 18; a report from the entity that the entity was not involved in a successfully completed confirmation event, or any combination of any of the preceding.

In operation, an entity identity management system 10 may involve communication among one or more parties involved in a confirmation of an identity. In an embodiment, as shown in FIG. 2, an identity manager 11 may be contained within a secure facility and communicating using a secure network. Communication among entities involved in a confirmation of the identity, and identity-related information, of one entity for the other, may be facilitated using a confirmation manager 14 of an identity manager 11. An identity manager 11 may include a secure data server with an encrypted, validated database 12 along with a registrar-verifier 42, an account manager 16, a confirmation manager 14, and a fraud detector 20. The fraud detector 20 may monitor any operations and/or data of the identity manager 11 to detect and/or prevent fraudulent use. An identity manager 11 centralizes a method by which any entity may maintain identity related information for accuracy and currency. Further, an identity manager 11 facilitates a control of the use of entity's identity and criteria for its confirmation in relation to an event connected with the entity. In addition, biometric data may be employed to facilitate a confirmation of an identity. An entity identity management system 10 provides secure, prompt, and redundant methods for identity confirmation. Further, such confirmation may be performed under the control of an entity and may vary from one entity to another and over time. In this manner, mere knowledge of personal information becomes irrelevant for purposes of proof of identity and provides an ability to curtail identity fraud. An identity may be confirmed without exposing the relevant information involved to confirming entity (or confirmation requestor) by using a formalized request protocol. Biological diversity within the human community may be accommodated.

An interface 18 accommodates any available communications media and may be specifically customized for each entity as per the needs of an entity. As of the filing of this application, telephone communications and world-wide-web/client access via a computer network are common methods. Standard telephonic signaling may be employed for data entry. Also, responses may be made by voice. For entities that cannot hear, a visual interface 18 such as text messaging may accommodate both sides of the dialog. Similarly, communications emphasizing various specific media for an accommodation of human biodiversity may be accommodated using the multi-media capabilities provided by a computer client and web browser access. Data communications may be encrypted. A GPS receiver or auto-location service interface may be included to accommodate entity auto-location. Biometrics may be implemented directly within a system employing specific biometric services and interface 18 as they become available. Where a biometric service is implemented externally, a communications link may be established with a protocol to establish a relationship between a specific measurement from the biometric service and a confirmation event coordinated by the invention.

A registrar-verifier 42 is used to register and verify an entity. A process may be initiated via personal computer over the Internet, although application forms may be mailed or faxed to or from those without computers or Internet communication. Registration may be initiated individually by each entity, or by a group entity for opt-in existing customers of a business or members of a group. An entity's status as a paying customer of a business or member of a group for a designated period of time may be taken as a factor in determining initial verifiability status. An entity may also register a newborn child who may be verified for birth date and location as well as citizenship status with a corresponding authority providing verification.

Routes for communication provided by an entity may be verified by test, including the mailing address. A recent photo, drivers license number, if possible, Social Security number or copy of Social Security card, if possible, and signature, if possible, all verified by notary public, may be required. A fingerprint may be solicited but may not be initially required. Registration may include a HIPAA release form allowing an entity's doctor to confirm a biological status of the entity with the identity manager 11. After an entity's doctor confirms an entity's disabilities, or lack thereof, and/or distinguishing features, and/or any biophysical limitations that may prevent the use of specific biometrics, the entity may be considered to be verified at the lowest level or grade. An entity may be granted higher grades of verification for operational purposes based on the amount of additional, verifiable information of relevance to identity confirmation. An entity may volunteer information, such as biometrics, which may be registered for verification at the request of the entity at any time.

FIGS. 11A, 11B, 11C and 12 illustrate an example of steps in the operation of registrar-verifier 42. An entity uses an interface 18 to access the registrar-verifier 42. Basic entity information 24 and transitory entity information 26 may be entered by the entity. Information relevant to entity biophysical status may be confirmed with the entity's doctor. All routes of communication claimed by the entity may be verified by test. Once verified, entity information may be registered with a fraud detector 20 before being activated in the validated database 12.

FIG. 11A: Registrar-verifier 42, Part 1
Step 4200: Start
Step 4202: If a new fact for a registered entity is being registered, proceed to Step 4203. If registration is for a new entity, proceed to Step 4204.
Step 4203: Prompt the entity for the details regarding the fact and its verification, and proceed to Step 4240.
Step 4204: Prompt user for entity type to be registered.
Step 4206: If registration is for natural-person entity, proceed to Step 4210. If for group entity, proceed to Step 4222.
Step 4210: Prompt entity for identity definition information for natural-person entity.
Step 4212: Prompt entity for postal address, phone, IP, email and other means of contact.
Step 4214: Prompt entity with psychological questionnaire

FIG. 11A: Registrar-verifier 42, Part 1
Step 4216: Prompt entity for distinguishing features, biophysical limitations, biometrics
Step 4218: Compose form for verification of natural-person entity
Step 4220: Assign unique identifier, temporary password, status of unconfirmed. Proceed to Step 4234.
Step 4222: Prompt entity for identity definition information for group entity.
Step 4224: Prompt entity for definition of subgroups and authority structure
Step 4226: Prompt entity for selection of natural-person registered entities in each subgroup and their respective authorities
Step 4228: Prompt entity for need for critical request access rights and details thereof
Step 4230: Compose form for registration of group entity.
Step 4232: Assign unique identifier, temporary password, status of unconfirmed.
Step 4234: Assign pass code and inform user of further instructions
Step 4236: Contact user via claimed electronic routes of communication and verify pass code.
Step 4238: Mail verification form to confirm indicated postal address.

FIG. 11B: Registrar-verifier 42, Part 2
Step 4240: Start
Step 4241: Receive form from user
Step 4242: If a new fact for a registered entity is being registered, proceed to Step 4290. If not, proceed to Step 4246.
Step 4246: If registration is for a natural-person entity, proceed to Step 4248. If not, proceed to Step 4268.
Step 4248: If all claimed routes of communication have been verified, proceed to Step 4254. If not, proceed to Step 4250.
Step 4250: Contact the entity to resolve the question of communication routes.
Step 4252: If the question of communication routes can be resolved, proceed to Step 4254. If not, proceed to Step 4266.
Step 4254: If the registration form has been completed and signed by a notary public, proceed to Step 4258. If not, proceed to Step

FIG. 11B: Registrar-verifier 42, Part 2 4256.
Step 4256: Return form to entity with further instructions. Proceed to Step 4284.
Step 4258: If the entity's doctor confirms the claimed biophysical status of the entity, proceed to Step 4264. If not, proceed to Step 4260.
Step 4260: Assign sub-optimal verification status noting lack of medical confirmation.
Step 4264: If entity agrees to terms of service, proceed to Step 4282. If not, proceed to 4266.
Step 4266: Cancel temporary account, log registration attempt and notify entity. Proceed to Step 4284.
Step 4268: If all claimed routes of communication have been verified, proceed to Step 4274. If not, proceed to Step 4270.
Step 4270: Contact the entity to resolve the question of communication routes.
Step 4272: If the question of communication routes can be resolved, proceed to Step 4274. If not, proceed to Step 4266.
Step 4274: If the registration form is complete, proceed to Step 4276 If not, proceed to Step 4256.
Step 4276: If group entity agrees to terms of service, proceed to Step 4278. If not, proceed to Step 4266.
Step 4278: Conduct formal communications with group representatives to confirm details of registration.
Step 4280: If the registration details can be confirmed, proceed to Step 4282. If not, proceed to Step 4266.
Step 4282 Assign verification grade, assign or accommodate digital signature, load form data into database, activate account and notify user with instructions.
Step 4284 End

FIG. 11C: Registrar-verifier, Part 3
Step 4290: Start
Step 4291 Verify item with relevant authority
Step 4292: If fact is verifiable, proceed to Step 4294. If not, proceed to Step 4296.

Step 4294: Add verified item to database and notify entity.

Step 4296: Notify entity item cannot be verified.

Step 4298: End

Information listed about an entity may include an independent confirmation status of a particular item. An entity may restrict or control public access to some or most information. An entity may enter additional information to be included for display, above and beyond the common minimum, when the public views the entity record. Identity data may be assembled into a meaningful identifier, with uniqueness accommodated by an entity's selection of a keyword or key phrase meaningful to the entity.

Once verified, an entity may be instructed to define sets of question-answer or prompt-response pair constructed from information specific to the entity's history, interests, activities, relationships, needs, preferences, and memories drawn from the entity's internal self-dialog. The entity may be instructed to rate these sets each according to its degree of sensitivity, designating sets employing casual use information from sets requiring progressively stronger degrees of protection. The entity may also be instructed to complete psychological and/or opinion surveys to be used in assisting the entity in the process and/or generating content related to entity needs and preferences and/or deeper redundancy of confirmation in critical situations.

Depending on any risk of spyware in a computer, much of the entity account control information may be read into the database using forms mailed in by the entity, instead of being entered directly from the computer. Each set and item then may be numbered or labeled so that an entity may select by number or label instead of entering the actual values when setting up the account via computer. Also, an entity may be supplied a card or small hardcopy identity code document with a checkerboard style grid (see e.g., FIG. 9C) with any number of columns and any number of rows containing a random, unique assortment of digits and/or characters, one digit or character per column and row combination. The checkerboard style grid may be used as a master reference such that column and row positions may be used to indicate or request passwords relevant to a specific document holder at any point in time.

Entities with visual disabilities may be provided with an audio and/or Braille-based interface. Entities with hearing disabilities may be provided a non-audio interface. Entities with mental disabilities may be provided templates customized for the specific disability and deeper support in the management of their identities. Entities with Alzheimer's disease or other serious or progressive mental disorders may have a verified legal guardian designated as a proxy.

A previously registered and verified entity using the registrar-verifier 42 may initiate registration of a group entity. A group entity may define an authority structure and registered entity within each subgroup and area of authority associated with the group entity. Once confirmed, a group entity account may serve as a guide for which natural-person entities may speak for the group entity. Also, natural-person entities may update the memberships of any subgroup of that group entity. No group entity may exist without at least one natural-person entity in control. The natural-person entities within a group entity may confirm their capacities in the group entity via their natural-person entity accounts.

A group entity may include law enforcement personnel or medical professionals. Members of such a group entity may want and/or need more than forgeable documents carried by the entity to assure a confirmation of the entity's identity. For example, in case of any one of a personal safety, a public safety, a medical safety (emergency), or any combination of any of the preceding, an entity may not be conscious or able to participate in the confirmation process. For this reason, natural-person entities of a group entity that may have an associated responsibility such as law enforcement and medical care may be granted immediate access to a confirmation dialog in such emergency situations. In turn, these natural-person entities may be granted access by the entity to information not used in a confirmation for business purposes, including information of a private nature.

A newly registered entity may remain in an unverified or sub-optimal entity status until sufficient points of verification may be obtained. The identity manager 11 may grant a verification authority regarding specific information to a group entity institution with authority relevant to any information in question. For example, members of a group entity registered as a local government or hospital may use the identity manager 11 to verify a birth date, location, citizenship status, and other information regarding a natural-person entity. Also, such group entities may verify when a natural-person entity is deceased. State or Provincial Departments of Motor Vehicles may use drivers' licenses and other information to verify the true identity and status of license applicants. Schools, colleges, and universities may verify the education level of a natural-person entity. Relevant state or province and local government entities may verify spousal and familial relationships. Registered entity associates may also add verification points to certain items claimed by the entity.

In an aspect of the present invention, an entity may use a guest account as a manner for being confirmed or obtaining the confirmation of an entity's identity. For example, while an entity is pursuing registration with the identity management system, a guest account may be used. Also, there may be occasions where a confirming entity (or confirmation requester) is neither a register natural-person entity nor a member of a registered group entity and a guest account may be used for a confirmation process.

An account manager 16 may be used by an entity for setting up an account for use, via the confirmation manager 14, according to entity's needs and preferences. As shown in FIG. 13, an entity may use an interface 18 to access the account manager 46. Updates to basic entity information 24 and transitory entity information 26 may be accessed through an entity person control panel 2350 of the entity account controls 23. Group entity information may be accessed through a group control panel 2360 of the entity account controls 23. New information requiring verification may be registered through a link to the registrar-verifier 42. Trusted associations 2310 in the entity account controls 23 may provide access to the personal infrastructure documents 4005 of another trusted natural-person entity in case of emergency, and to the account change review and approval role for the designated account control confirmer 2304. Links may be provided for updates to an entity association profile 36, an entity description profile 40 and a confirmation control profile 30. Account access and/or update activities may be monitored by a fraud detector 20 before such updates are applied to the validated database 12.

A registrar-verifier 42 may be available from the account manager 16 to initiate a new group entity account, or to register additions or updates to basic entity information 24 such as biometrics, GPS registration, or other relevant fact. Once the fact can be independently verified, it is added to the entity account file.

It is most likely that access may be by a personal computer over the Internet, though those without such access may be provided mailed or faxed forms and a telephone interface 18. Data communications with an account manager 16 may be encrypted. A logon may require coordination with a prior telephone call to retrieve a PIN until security against spyware may be assumed. Also, this may be accommodated with a password grid document, as discussed above. An entity may choose to be notified, via media chosen by the entity, after any account manager 16 access. The account manager 16 may allow an entity to update various sections of the validated database 12 as shown in FIGS. 6 and 7.

Entity account controls 23 of FIG. 6 may be used to designate general account usage controls. An entity association profile 36 may provide a means for an entity to enhance a confirmation status by indicating associations with other registered entities. Each pairing of entities is to be confirmed by both entities as an entry in the association profile 36 of both entities, with common keywords to indicate shared interests and activities. This can also serve as the basis of a question to be asked anyone using the entity's name.

Entity description profile 40 of FIG. 8 provides a means for the creation of documents related to an entity's needs and preferences as they may apply to an area of business, or to a specific group entity. These documents may be made available to a business to automate the process of providing commonly needed information. This includes a section of information labeled for the public record. Here the entity may ensure placement on a virtual list. The entity may select limited items from this profile to be included in the display of the entity record to the public and predefined group entities or group classes.

An entity confirmation control 30 allows an entity to define a set of easily remembered password prompts and replies as shown in FIG. 9A, and to manually or randomly select the password prompts and replies in effect for any period of time, and for any confirmation context in a confirmation-control record 3041 as shown in FIG. 9B. An entity may also define a phone number or other contact media address for the service to use in contacting the entity during a confirmation event. These controls may be put on repeatable schedules, and the control for one context may be used as a default for others not otherwise defined, so they require little maintenance. They are used in collaboration with the confirmation-request record 1401 employed during confirmation events.
a. One confirmation control context is reserved for use as additional criteria of proof in addition to the logon password when accessing the account manager 16 itself. This allows the entity to anticipate the times account access may be needed and schedule off-time during which not even a legitimate logon is accepted. This is done to give the entity full control over the availability of the entity account manager 16 to prevent fraudulent access.
b. In addition to the prompts and replies defined in advance by the entity, a general purpose confirmation password, created by the identity manager 11 or by the entity, is changed at intervals that may be selected by the entity. This password may consist of a combination of alpha-numeric characters, a word or brief phrase in combination with one or more numbers of one or more digits each. The entity may specify whether this password may be used in place of, or in addition to, a predefined prompt and reply pair for certain classes of confirmation events. This password is defined in a confirmation dialog record 3001 reserved specifically for the purpose.

c. A unique grid password 3070 that is provided to the entity on a card upon registration and verification is stored for comparison purposes. The entity may be prompted for the value contained within a section of the grid, used primarily when verification via the usual means has proven insufficient.

Separate control records for each confirmation context may accommodate separate schedules and confirmation dialogs for each purpose, or multiple confirmation contexts can share the same control record. Selected confirmation contexts may not be permitted without a corresponding confirmation-control record 3041, as determined by the confirmation control options 2302 in the entity account controls 23.

Requests with a confirmation context of a critical nature grant access to more entity information and use the associated control records only as the first of several possible methods in verification.

Turning now to FIGS. 14, 15, 16A, 16B, 16C, 16D, 17A, 17B, 17C, 17D, 17E, 17F, and 17G, the confirmation manager 14 may be used for confirming an entity identity and entity identity related information in real time. It may employ a formalized protocol for supporting different purposes and contexts of confirmation, primarily for distinguishing confirmation for critical purposes, such as those involving medical emergencies and law enforcement, from casual and business-related purposes. Critical situations require immediate access to possibly more personal information and accommodation for the possibility that the entity to be confirmed is not conscious or able to participate. Non-critical situations require various degrees of entity control generally not involving sensitive access, and must at some point give the entity the ability to require a confirmation password exchange in addition to any required biometrics involved, and to deny even the possibility of confirmation for particular purposes at particular times and under particular conditions, even if biometric measurements show a match, until they are allowed via Confirmation Control Profile updates, whether manual or scheduled. For example, large credit lines and mortgages are generally planned in advance.

At the center of this protocol may be a confirmation-request record 1401 (see, e.g., FIG. 14), which identifies the roles of all parties involved, the date and time of the request, the date and time of execution, status, result, and parameters involved in supporting specific confirmation purposes. As shown in FIG. 14, the confirmation-request record 1401 is matched with an accommodating confirmation-control profile 30.

| | |
|---|---|
| Step 1 | Confirming entity or entity uses interface 18 to access |
| | confirmation manager 14 to query the database in the process of |
| | creating a confirmation request record. The entity may supply a |
| | keyword to the confirming entity. The confirmation context and |
| | the date are used as the basis for a match with a relevant |
| | confirmation control record created in advance by the entity. If |
| | the request keyword matches with that on the control record, or |
| | the request is of a critical context, the confirmation exchange |
| | may be routed via the confirming entity account connection. If |
| | an alternate contact method (replyvia) is supplied in the request, |
| | the confirmation manager uses it as a first choice in initiating |
| | contact with the entity. |
| Step 2 | The password prompt is sent to the account connection |
| | established for the confirmation exchange. If the entity is |
| | replying through the entity account connection, this may be |
| | preceded by a prompt for the confirmation request number to |
| | verify that the person replying via the entity account is the same |
| | person replying via their initial or primary mode of |
| | communication. If the confirmation exchange is routed via the |
| | confirming entity account connection, the prompt is |
| | communicated to the entity. |

FIG. 14: Confirmation Manager 14

| | |
|---|---|
| Step 3 | The password reply is sent to the confirmation manager, |
| | possibly in combination with location data, observation results |
| | and biometrics, for comparison with the predefined criteria. If |
| | the confirmation exchange is routed via the confirming entity |
| | account, the entity may communicate that reply to the |
| | confirming entity to enter. |
| Step 4 | The results are evaluated and passed to the fraud detector for |
| | final approval. |
| Step 5 | Final results are communicated to confirming entity and entity, |
| | and request log is updated. |

FIG. 14: Confirmation Manager 14

Turning now to FIGS. 16A, 16B, 16C, and 16D that show a number of scenarios, a confirmation request starts with either a request for confirmation from the confirming entity (or confirmation requester), or a request for request for confirmation from the entity to be confirmed, and can be refused by either entity except for purposes designated as critical, such as law enforcement or medical emergency. Optimally this occurs with each entity logged on to a corresponding confirmation manager account. The entity to be confirmed may have predefined a telephone number or other media address for the identity manager 11 to use in contacting the entity regarding a confirmation request. To guarantee that the entity to be confirmed, currently responding via the identity manager 11 account, is the same person being corresponded with via other media being used in the transaction, the entity to be confirmed is prompted for the confirmation request identifier issued by the identity manager 11 and presented so far only to the confirming entity (or confirmation requester), who must communicate that identifier to the entity to be confirmed via their current other mode of communication. The entity to be confirmed interacts to reply to the prompt(s) issued by the confirmation manager 14 and chosen by the entity previously.

For example, in the scenario FIG. 16A, a confirmation manager 14 used to open a line of credit account of or an ecommerce account.

| | |
|---|---|
| Optional | Entity may create service document in description profile |
| Preparation | defining typical needs for the type of business or service |
| | requested. |
| Step 1 | Entity and confirming entity access respective accounts. |
| | Confirming entity submits confirmation request and |
| | provides entity with confirmation request identifier. |
| Step 2 | Entity replies to request notification with request identifier, |
| | then engages in prompt-reply exchange to confirm. |
| | Biometric measurement is taken, if needed and |
| | configured, over a separate channel (not shown). |
| Step 3 | Confirmation manager informs both entities of results. If |
| | confirmation is successful and a service document has been |
| | associated with the event, the service document is |
| | transmitted to the confirming entity. |

For example, in the scenario FIG. 16B, a confirmation manager 14 used for a limited access or an expedited confirmation.

| | |
|---|---|
| Step 1 | Confirming entity requests confirmation from entity. Entity |
| | provides confirming entity the keyword that matches a relevant |
| | confirmation control. Confirming entity accesses respective |
| | account, including the keyword supplied by the entity in the |
| | confirmation request. |
| Step 2 | Confirming entity reads prompt from control record to entity. |
| | Entity provides reply for confirming entity to enter into the |
| | confirmation manager. Alternatively, the entity may read the |
| | prompt and supply the answer directly using the confirming |
| | entity's connection interface. Biometric measurement is taken, |
| | if needed and configured, over a separate channel (not shown). |
| Step 3 | The confirmation manager provides the result via the confirming |
| | entity account connection. |

For example, in the scenario FIG. 16C, a confirmation manager 14 used for an emergency confirmation.

| | |
|---|---|
| Step 1 | Confirming entity accesses account to submit queries on the |
| | database based on a name or identifier found on the entity, |
| | possibly in combination with the location, the sex, distinguishing |
| | features and accompanying items discovered regarding the |
| | entity. |
| Step 2 | Confirming entity selects entity record from results of query, one |
| | at a time, to submit a confirmation request and access the full |
| | description of the entity. Confirming entity compares each item, |
| | logging all relevant results. Biometric measurements are taken, |
| | if configured, and compared with the documented biometric |
| | template. Confirming entity contacts other entities documented |
| | by the entity to assist in determining identity, and to provide |
| | emergency notification. Once identity is confirmed, confirming |
| | entity accesses medical requirements information and contacts |
| | the medical information service documented by the entity |
| Step 3 | The confirming entity logs results of all manual comparisons. |

For example, in the scenario FIG. 16D, a confirmation manager 14 used for a face-to-face commerce or an expedited access confirmation.

| | |
|---|---|
| Step 1 | Confirming entity requests confirmation from entity. Entity |
| | provides confirming entity the identifier and either a keyword |
| | that matches a relevant confirmation control or a password. |
| | Confirming entity accesses respective account, including the |
| | keyword or password supplied by the entity in the confirmation |
| | request. |
| Step 2 | Confirmation manager provides the result to the confirming |
| | entity. Confirming entity informs the entity. |

Typically, the confirming entity (or confirmation requester) need only know, as a report from the confirmation manager 14, whether the entity to be confirmed has replied correctly. If access to communication is limited or the request needs to be expeditious, the exchange may be accommodated via the confirming entity (or confirmation requestor) account, in which case it is operationally acknowledged or assumed 1) that the entity to be confirmed has consented to any request of a non-critical nature, and 2) that the confirming entity (or confirmation requestor) has seen, or may have seen the specific prompts and replies involved. For requests of a critical nature, access to the confirmation dialog via the confirming entity (or confirmation requestor) account is easily accommodated by mere specification of a keyword with no match necessary. For non-critical requests, if the request contains a keyword, supplied by the entity to be confirmed, that matches the relevant confirmation-control record 3041, access to the confirmation exchange is immediately granted via the confirming entity (or confirmation requester) account. However, for non-critical requests, the confirmation manager 14 does not allow repeated access using the keyword by the same confirming entity (or confirmation requestor) beyond the context of a single confirmation event. Alternatively the entity may allow for the mere specification of the relevant prompt itself to accommodate this access.

A confirmation request may be initiated simply for one natural person entity to verify another entity, or for a business group entity to verify another entity through a natural person entity member acting on its behalf. When requesting confirmation, the confirming entity (or confirmation requestor) can specify the context of the confirmation with accompanying parameters in order to accommodate the specific purposes of the context. When confirming for opening a mortgage or new line of credit, for example, or when confirming a common purchase, the dollar amount involved can be specified. Passing the associated group entity identifier as a parameter in the request can accommodate confirming an entity's association and role with a group entity, even before the entity in question has actually engaged in the confirmation dialog. Similarly, a document name from the entity description profile 40 may be specified in order to automate filling out forms with a new business. Another context may be reserved for home security applications. Certain contexts, such a medical emergency or law enforcement matter, are designated to be of a critical nature, and require the option of allowing a confirming entity (or confirmation requester) that has been verified as authorized for the purpose access to information of a more private nature, especially if the entity is unconscious and cannot participate via the usual methods. A link can also be made available to the specific medical information service and account relevant to effective treatment.

A confirmation manager 14 may track the running status of any identity confirmation request, as well as all activity related to the access of entity information. It informs the entity of the number of times a password or other confirmation-related or sensitive information has been exposed, or likely been exposed, over the course of confirmation events. The confirmation-request records 1401 are contained in a continuous log. An entity has access to, or a copy of, all confirmation requests in which the entity has participated. This provides a log for businesses to show proof that the invention was used in confirming the identity of new customers. The entity to be confirmed is notified, via media selected by the entity in the account manager 16, upon completion of every confirmation event relevant to the entity, whether successful or not.

Turning now to FIGS. 17A, 17B, 17C, 17D, 17E, 17F, and 17G that show examples of detailed flow charts for an aspect of a process including a confirmation manager according to an aspect of the present invention.

FIG. 17A shows an example of a flow chart for a first part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17A: Confirmation Manager 14, Part 1
Step 17000: The confirmation manager is initiated to accept account access.
Step 17001: The confirming entity may or may not be logged in to associated confirmation manager account.
Step 17002: The entity to be confirmed may or may not be logged into associated confirmation manager account.
Step 17004: A query may be made of whether the confirming entity wants to initiate a request to confirm. If not, proceed to step 17016. If so, proceed to step 17008.

FIG. 17A: Confirmation Manager 14, Part 1
Step 17006: A query may be made of whether the entity wants to initiate a request to be confirmed. If not, proceed to step 17018. If so, proceed to step 17010.
Step 17008: The confirming entity may query the database and retrieve the entity record to compare photograph with appearance of entity and request confirmation, proceeding to step 17100
Step 17010: The entity may query the database and retrieve the confirming entity record to request to be confirmed, proceeding to step 17100
Step 17100: The requesting entity completes a confirmation request form
Step 17200: The request is sent to the other entity
Step 17016: A query may be made of whether a confirmation request is being received by the confirming entity. If so, proceed to Step 17020. If not, proceed to Step 17004.
Step 17018: A query may be made of whether a confirmation request is being received by the entity. If so, proceed to Step 17022. If not, proceed to Step 17006.
Step 17020: The logon status of the confirming entity is checked. If entity can be brought online, proceed to Step 17024. If not, proceed to Step 17034.
Step 17022: The logon status of the entity is checked. If entity can be brought online or request contains a keyword, proceed to Step 17026. If not, proceed to Step 17034.
Step 17024: The confirming entity may be presented with a prompt requesting whether the entity accepts the confirmation request. If entity accepts request, proceed to Step 17200. If not, proceed to Step 17034.
Step 17026: A determination may be made as to whether the request is of a critical nature. If so, proceed to Step 17030. If not, proceed to Step 17028.
Step 17028: The entity may be presented with a prompt requesting whether the entity accepts the confirmation request. If entity accepts request, proceed to Step 17030. If not, proceed to Step 17034.
Step 17030: Acceptance of confirmation request is noted
Step 17300: The entity's confirmation control is executed

FIG. 17A: Confirmation Manager 14, Part 1
Step 17400: The results of the confirmation exchange(s) are calculated and both entities are notified of the results. Proceed to Step 17036.
Step 17034: The requesting entity is notified that the request currently cannot be accommodated.
Step 17036: Finish

FIG. 17B shows an example of a flow chart for a second part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17B: Confirmation Manager 14, Part 2
Step 17100: Start
Step 17102: The confirmation request form is presented as prompt to requesting entity to obtain request details
Step 17104: Depending on the request details, a parameter may be required. If so, proceed to Step 17106. If not, proceed to Step 17120.
Step 17106: If the required parameter has been supplied, proceed to Step 17108. If it has not been supplied, proceed to Step 17116.
Step 17108: Depending on the request details, a parameter match with a predetermined item may be required. If so, proceed to Step 17110. If not, proceed to Step 17120.
Step 17110: If the parameter matches with a predetermined item, proceed to Step 17118. If not, proceed to Step 17112.
Step 17112: The requesting entity may be informed of the lack of a match.
Step 17114: The requesting entity may be prompted whether to retry for a match, continue without a match, or cancel. If the reply is to retry, proceed to Step 17116 . If the reply is to continue, proceed to Step 17120. If the reply is to cancel, proceed to Step 17132.
Step 17116: The requesting entity is prompted for the parameter. Proceed to Step 17102.

FIG. 17B: Confirmation Manager 14, Part 2
Step 17118: The requesting entity may be informed of the match.
Step 17120: If a keyword has been supplied in the request, proceed to Step 17122. If not, proceed to Step 17126.
Step 17122: If the keyword matches a confirmation control keyword in entity's profile, or the request is of a critical nature, proceed to Step 17124. If neither condition is true, proceed to Step 17126.
Step 17124: Configure to route entity confirmation exchange via the confirming entity's account connection. Proceed to Step 17130.
Step 17126: If an alternate call back method (replyvia) has been supplied, proceed to Step 17128. If not, proceed to Step 17130.
Step 17128: Configure alternate call back in place of entity's usual means of contact.
Step 17130: Assign a unique request identifier and create request record.
Step 17132: End

FIG. 17C shows an example of a flow chart for a third part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17C: Confirmation Manager 14, Part 3
Step 17200: Start
Step 17202: If the request has been scheduled in advance for later execution, proceed to Step 17203. If not, proceed to Step 17204.
Step 17203: Put the request in a request input queue for execution at the scheduled time. Proceed to Step 17264.
Step 17204: If the request is being submitted from the entity as a request to be confirmed, proceed to Step 17246. If not, proceed to Step 17206.
Step 17206: If the receiving entity, to which the request is being transmitted, is online, proceed to Step 17216. If not, proceed to Step 17208.

FIG. 17C: Confirmation Manager 14, Part 3
Step 17208: If the request has a keyword that matches a confirmation control keyword in entity's profile, or the request is of a critical class and any keyword is present, proceed to Step 17214. If neither condition is true, proceed to Step 17210.
Step 17210: Contact the entity using predefined methods (CallMeAtThisNumber) and prompt for confirmation manager logon.
Step 17212: If the entity has been contacted, proceed to Step 17216. If not, proceed to Step 17230.
Step 17214: Set the condition that the entity's confirmation exchange will execute via the confirming entity's account connection. Set the condition that the entity has been contacted and accepts the confirmation request. Proceed to Step 17264.
Step 17216: Notify entity of confirmation request and prompt for acceptance.
Step 17218: If entity accepts confirmation request, proceed to Step 17220. If not, proceed to Step 17219.
Step 17219: Note rejection of request in request log. Proceed to Step 17264
Step 17220: The entity is prompted for the request identifier.
Step 17222: If the entity can supply the request identifier, proceed to Step 17258. If not, proceed to Step 17230.
Step 17230: Set the condition that the entity has not been contacted. Proceed to Step 17264.
Step 17246: If the receiving entity, to which the request is being transmitted, is online, proceed to Step 17252. If not, proceed to Step 17248.
Step 17248: Contact the confirming entity using predefined methods (CallMeAtThisNumber) and prompt for confirmation manager logon.
Step 17250: If the confirming entity has been contacted, proceed to Step 17252. If not, proceed to Step 17230.
Step 17252: Notify confirming entity of confirmation request and prompt for acceptance.
Step 17254: If confirming entity accepts confirmation request, proceed to Step 17258. If not, proceed to Step 17256.
Step 17256: Note rejection of request in request log. Proceed to Step 17264.
Step 17258: Log acceptance of request and set the condition that the entity has been contacted.

FIG. 17C: Confirmation Manager 14, Part 3
Step 17264 End

FIG. 17D shows an example of a flow chart for a fourth part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17D: Confirmation Manager 14, Part 4
Step 17300: Start
Step 17302: If the request is of a critical nature, proceed to Step 17304. If not, proceed to Step 17308
Step 17304: Retrieve confirmation control for critical class events
Step 17306: If control record was found, proceed to Step 17314. If not, proceed to Step 17312
Step 17308: Retrieve confirmation control for designated context
Step 17310: If control record was found, proceed to Step 17314. If not, proceed to Step 17312
Step 17312: Determine default control set
Step 17314: Check entity location compared with location area defined by entity account and log result
Step 17316: If the request is of a critical nature, proceed to Step 17318. If not, proceed to Step 17500
Step 17318: If the confirming entity has indicated that the entity is unconscious, proceed to Step 17600. If not, proceed to Step 17500.
Step 17320: If the confirmation methods indicate positive identification, proceed to Step 17326. If not, proceed to Step 17322.
Step 17322: If more attempts are allowed, proceed to Step 17500. If not, proceed to Step 17324.
Step 17324: Make note of the failed confirmation exchange. Proceed to Step 17328.
Step 17326: Make note of the successful confirmation exchange.

FIG. 17D: Confirmation Manager 14, Part 4
Step 17328: If another method of confirmation is available, proceed to Step 17500. If not, proceed to Step 17330.
Step 17330: If the request is of a critical nature, proceed to Step 17600. If not, proceed to Step 17342
Step 17332: If the confirmation manager and other measures indicate positive identification, proceed to Step 17338 . If not, proceed to Step 17334 .
Step 17334: If more attempts are feasible, proceed to Step 17600. If not, proceed to Step 17336
Step 17336: Make note of the failed confirmation exchange. Proceed to Step 17340
Step 17338: Make note of the successful confirmation exchange.
Step 17340: If another method of confirmation measurement is available, proceed to Step 17600. If not, proceed to Step 17342.
Step 17342 End

FIG. 17E shows an example of a flow chart for a fifth part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17E: Confirmation Manager 14, Part 5
Step 17500: Start
Step 17502: Provide confirmation exchange prompts to entity
Step 17504: Obtain replies from entity
Step 17506: Log results of exchange
Step 17510: If the request is of a critical nature, proceed to Step 17512. If not, proceed to Step 17514.
Step 17512: Provide access to entity association profile and description profile to obtain personal information for use in forming questions to ask entity.
Step 17514: Take biometric measurement if indicated
Step 17516: Log all results
Step 17518: End

FIG. 17F shows an example of a flow chart for a sixth part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17F: Confirmation Manager, Part 6
Step 17600: Start
Step 17602: Provide information about physical features for comparison
Step 17604: Provide biometrics for comparison if available
Step 17606: Provide information about items typically found with entity for comparison
Step 17608: Provide contact person to call for assistance in determining identity
Step 17610: Provide biological requirements if entity is having a medical emergency. Provide link to medical information service used by entity.
Step 17612: Provide contact person to call in case of emergency
Step 17614: Log all results
Step 17616: End

FIG. 17G shows an example of a flow chart for a seventh part of an aspect of a process including a confirmation manager according to an aspect of the present invention while using any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 17G: Confirmation Manager 14, Part 7
Step 17400: Start
Step 17402: If the request is of a critical nature, proceed to Step 17408. If not, proceed to Step 17404.
Step 17404: If the entity location matches the specified location area and is designated relevant, proceed to Step 17405. If not, proceed to Step 17406.
Step 17405: Record the location factor
Step 17406: If the entity has provided correct answers in the confirmation exchange, proceed to Step 17407. If not, proceed to Step 17416
Step 17407: Record the answers factor. Proceed to Step 17416.
Step 17408: If the entity location matches the specified location area and is designated relevant, proceed to Step 17409. If not, proceed to Step 17410
Step 17409: Record the location factor
Step 17410: If the comparisons and measurements made of the entity match those documented by the entity, proceed to Step 17411. If not, proceed to Step 17412.
Step 17411: Record the measurements factor
Step 17412: If the entity is not conscious, proceed to Step 17416. If the entity is conscious, proceed to Step 17414
Step 17414: If the entity has provided correct answers in the confirmation exchange, proceed to Step 17415. If not, proceed to Step 17416.
Step 17415: Record the answers factor.
Step 17416: Calculate the temporary result from all previous factors.
Step 17418: If biometric measurement was taken and matches that of the entity, proceed to Step 17419. If not, proceed to Step 17420.
Step 17419: Record the biometric factor.
Step 17420: Calculate final result and compare with score criteria defined by participating entities. If confirmation is positive, proceed to Step 17422. If not, proceed to Step 17421.
Step 17421: Inform participating entities of confirmation failure and record failure in request log. Proceed to Step 17428
Step 17422: Inform participating entities of positive confirmation and record success in request log.
Step 17424: If a document was requested as part of the confirmation request, proceed to Step 17426. If not, proceed to Step 17428.

FIG. 17G: Confirmation Manager 14, Part 7
Step 17426: Transmit document to confirming entity account.
Step 17428: Close request and send alternate notification to entity.
Step 17430: End

A fraud detector 20 may monitor the activity of each entity account for indications of fraudulent activity starting at the point of initial registration with the registrar-verifier 42 and including the confirmation manager 14. The fraud detector alarm 50 is raised when the fraud detector 20 perceives activity that indicates possible or certain fraudulent intent on the part of either entity involved in the confirmation process. The alarm 50 initiates the investigator 54, which determines the nature and degree of the threat and recommends and/or initiates corrective response. An entity account may be impaired or disabled when suspicious activity is detected, and re-enabled upon satisfactory resolution of suspicion.

Starting with initial registration, entity communications and entity accounts may be monitored for conditions indicating possible fraud or abuse. Such conditions may include:
when two or more entities claim the same unique identifier, such as Social Security or driver's license number, fingerprint, or other metric.
when a person claims relevant information that proves untrue upon independent confirmation
when the identity manager 11 is used in a way contrary to previous behavior and/or explicit instruction from the entity upon registration
when an entity reports that entity wasn't actually involved in a successfully completed confirmation event
when access to account manager 16 is attempted outside of the date range defined by the entity
when access to account manager 16 is attempted outside of the IP address range defined by the entity
when there is obvious or repeated failure to successfully confirm identity
when there is a cookie mismatch using the web interface 18
when there is a high degree of activity confirming a single entity
when an online entity to be confirmed rejects a confirmation request supplied with a keyword
when an entity repeatedly rejects confirmation requests
when an entity repeatedly issues confirmation requests for the same other entity

On occasion and during transactions requiring verified confidentiality, the fraud detector 20 issues a request to the entity to confirm such items as the value contained in a coordinate section of the identity code document issued to the entity after verification and the important keywords or statements registered by the entity after verification.

Turning now to FIG. 19 that shows an example of a detailed flow chart for fraud detector 20 according to an aspect of the present invention and usable with any one of an identity management system of FIG. 1, an identity manager of FIG. 2, a validated database of FIG. 3 and/or any other aspects (whether any other aspect is taken alone or in any combination of aspects) of the present as may be illustrated and/or disclosed.

FIG. 19: Fraud Detector 20
Step 2000: Start Activity Monitor
Step 2002: If multiple entities claim the same unique identifier, proceed to Step 2020.
Step 2004: If information supplied by entity is discovered to be false, proceed to Step 2020.
Step 2006: If a web cookie mismatch is detected, proceed to Step 2020.
Step 2008: If access to entity account manager fails due to unscheduled attempts, proceed to Step 2020
Step 2010: If repeated failures to logon to entity account are detected, proceed to Step 2020.
Step 2012: If entity confirmation attempts result in failure, proceed to Step 2020.

FIG. 19: Fraud Detector 20
Step 2014: If entity account usage is contrary to historical or explicitly anticipated patterns, proceed to Step 2020.
Step 2015: If entity has reported entity was not involved in a successful confirmation event, proceed to Step 2020.
Step 2016: If the fraud detector is commanded to terminate, proceed to Step 2018. If not, proceed to Step 2002.
Step 2018: End
Step 2020: Trigger alarm to initiate incident manager task. Proceed to Step 2002.
Step 2030: Start Incident Manager Task
Step 2032: Notify investigating agent
Step 2034: Determine whether the entity account should be disabled. If so, proceed to Step 2306. If not, proceed to Step 2308
Step 2036: Disable entity account.
Step 2038: Determine whether the entity should be notified. If so, proceed to Step 2040. If not, proceed to Step 2042.
Step 2040: Notify the entity.
Step 2042: Consult investigating agent for resolution options
Step 2044: If the incident can be rectified, proceed to Step 2046. If not, proceed to Step 2048.
Step 2046: Implement resolution and re-enable entity account. Proceed to Step 2050.
Step 2048: Suspend account and notify entity.
Step 2050: End
Accordingly, one aspect of the present invention is to provide an entity identity management system 10 including an identity manager 11. The identity manager 11 includes a validated database 12 and a confirmation manager 14.

Another aspect of the present invention is to provide an identity manager 11 usable in an entity identity management system 10. The identity manager 11 includes a validated database 12 and a confirmation manager 14. The validated database 12 includes entity-controllable data 22.

Still another aspect of the present invention is to provide an entity identity management system 10, a validated database 12, a confirmation manager 14, and an interface 18. The validated database 12 includes entity-controllable data 22.

Certain modifications and improvements will occur to those skilled in the art upon a reading of the foregoing description. For example, the entity identity management system 10 of the present may accommodate manners of confirmation including any one of: an entity providing keyword granting access to a relevant confirmation prompt, or entity proving actual relevant confirmation prompt; an entity providing a correct reply to relevant confirmation prompt; an entity providing a current confirmation password; an entity providing password that grants access to a relevant item of entity information; an entity accessing an entity account and replying to a confirmation request notification with a correct request identifier; an entity accessing an entity account, replying to a confirmation request notification with a correct request identifier, and providing a correct reply to relevant confirmation prompt, or any combination of any of the preceding. For another example, the parameter defined in the confirmation control record could also be used to match with the confirmation request record for more detailed coordination of response. For another example, information transfer during confirmation could be accommodated in either or both directions between confirmation requestor and entity, not just from the entity to the confirmation requester. It should be understood that all such modifications and improvements have been deleted herein for the sake of conciseness and readability but are properly within the scope of the following claims.

I claim:

1. An entity identity management system comprising:
(a) an identity manager including a validated database; and
(b) a confirmation manager.

2. The entity identity management system according to claim 1, further including an interface.

3. The entity identity management system according to claim 2, wherein the interface is adapted for communication using a secure sockets layer type protocol.

4. The entity identity management system according to claim 2, wherein the interface comprises any one of a wired interface, a wireless interface, or a wired and a wireless interface.

5. The entity identity management system according to claim 4, wherein the interface comprises a network.

6. The entity identity management system according to claim 5, wherein the network comprises any one of an intranet, an internet, a telephone network, or any combination of any of the preceding.

7. The entity identity management system according to claim 2, wherein the interface is adapted for communication using any one of a telephonic type device, a computer type device, a television type device, a relative positioning type device, or any combination of any of the preceding.

8. The entity identity management system according to claim 7, wherein the telephonic device is any one of a facsimile device, telephone device, a screen phone device, a video phone device, a mobile phone device, a web terminal device, a web pad device, a computer device, or any combination of any of the preceding.

9. The entity identity management system according to claim 8, wherein the computer device is adapted for any one of a specialized client application, a web browser, or a specialized client application and a web browser.

10. The entity identity management system according to claim 8, wherein the computer device is any one of a personal computer, a gaming device, or any combination of any of the preceding.

11. The entity identity management system according to claim 10, wherein the personal computer is any one of a desktop computer, a notebook computer, a tablet computer, a palmtop type computer, or any combination of any of the preceding.

12. The entity identity management system according to claim 7, wherein the computer type device is adapted for any one of a specialized client application, a web browser, or a specialized client application and a web browser.

13. The entity identity management system according to claim 7, wherein the computer type device comprise a personal computer comprising any one of a desktop computer, a notebook computer, or a desktop computer and a notebook computer.

14. The entity identity management system according to claim 7, wherein the computer types device is any one of a gaming type device, a personal digital assistant (PDA) type device, or a gaming type device and a personal digital assistant (PDA) type device.

15. The entity identity management system according to claim 7, wherein relative positioning type device is adapted for any one of a hyperbolic positioning type device, a trilateration type device, or a hyperbolic positioning type device and a trilateration type device.

16. The entity identity management system according to claim 15, wherein any one of a hyperbolic positioning type device, a trilateration type device, or a hyperbolic positioning type device and a trilateration type device comprises a global positioning type device.

17. The entity identity management system according to claim 2, wherein the interface is adapted for using password protection

18. The entity identity management system according to claim 17, wherein the password protection comprises a using plurality of passwords.

19. An identity manager usable in an entity identity management system, the identity manager comprising:
(a) a validated database including entity-controllable data; and
(b) a confirmation manager.

20. An identity manager according to claim 19, wherein least a portion of the entity-controllable data comprises encrypted entity-controllable data.

21. The identity manager according to claim 19, wherein the validated database includes basic entity information.

22. The identity manager according to claim 21, wherein the basic entity information includes a uniqueness identifier.

23. An identity manager according to claim 22, wherein the basic entity information is associated with any one of an entity that is a natural-person entity, an entity that is other than a natural-person entity, or any combination of any of the preceding.

24. The identity manager according to claim 23, wherein the basic entity information is associated with the natural-person entity includes any one of a name, a sex, a city of birth, a date of birth, a mother's maiden name, a photograph of a natural-person entity, a signature of a natural-person entity, a digital signature of a natural-person entity, a marital status, a uniqueness phrase, a nations of citizenship, a primary spoken language, a secondary spoken language, a fingerprint, a driver's license number, or any combination of any of the preceding.

25. The identity manager according to claim 24, wherein the name includes any one of a first name, a middle name, a last name, or any combination of any of the preceding.

26. The identity manager according to claim 25, wherein the name includes a full name.

27. The identity manager according to claim 24, wherein any one of the photograph of a natural-person entity, the signature of a natural-person entity, or the photograph and the signature of a natural-person entity include relatively recent versions thereof.

28. The identity manager according to claim 22, wherein the basic entity information associated with the entity that is other than a natural-person entity includes any one of information associated with at least one natural-person entity that is a member of the entity, information associated with at least one authorized natural-person entity that is a member of the entity, a name of the entity, a name of an entity related to the entity, an industrial classification of the entity, at least one aspect of an address for the entity, a legal category for the entity, or any combination of any of the preceding.

29. The identity manager according to claim 28, wherein the basic entity information associated with the entity includes information associated with at least one natural-person entity associated with the entity including any one of a name, a sex, a city of birth, a date of birth, a mother's maiden name, a photograph of a natural-person entity, a signature of a natural-person entity, a digital signature of a natural-person entity, a marital status, a uniqueness phrase, a nation of citizenship, a primary spoken language, a secondary spoken language, a fingerprint, a driver's license number, or any combination of any of the preceding.

30. The identity manager according to claim 29, wherein the name includes any one of a first name, a middle name, a last name, or any combination of any of the preceding.

31. The identity manager according to claim 30, wherein the name includes a full name.

32. The identity manager according to claim 31, wherein any one of the photograph of a natural-person entity, the signature of a natural-person entity, or the photograph and the signature of a natural-person entity include relatively recent versions thereof.

33. The identity manager according to claim 28, wherein the at least one natural-person entity that is a member of the entity includes at least one authorized natural-person entity.

34. The identity manager according to claim 33, wherein the basic entity information associated with the entity includes information associated the at least one authorized natural-person entity including any one of a title a name, a sex, a city of birth, a date of birth, a mother's maiden name, a photograph of a natural-person entity, a signature of a natural-person entity, a digital signature of a natural-person entity, a marital status, a uniqueness phrase, a nation of citizenship, a primary spoken language, a secondary spoken language, a fingerprint, a driver's license number, or any combination of any of the preceding.

35. The identity manager according to claim 34, wherein the name includes any one of a first name, a middle name, a last name, or any combination of any of the preceding.

36. The identity manager according to claim 35, wherein the name includes a full name.

37. The identity manager according to claim 36, wherein any one of the photograph of a natural-person entity, the signature of a natural-person entity, or the photograph and the signature of a natural-person entity include relatively recent versions thereof.

38. The identity manager according to claim 28, wherein the basic entity information associated with the entity includes information associated a name of the entity including any one of a fictitious business name or doing business as (dba) name, a registered name, or any combination of any of the preceding.

39. The identity manager according to claim 28, wherein the basic entity information associated with the entity includes the name of an entity related to the entity including any one of a name of a parent entity of the entity, a name of an intermediate parent of the entity, a name of the ultimate parent entity of the entity, or any combination of any of the preceding.

40. The identity manager according to claim 28, wherein the basic entity information associated with the entity includes the industrial classification of the entity including any one of a sector for the entity, a standard industrial classification, the North American Industry Classification System, or any combination of any of the preceding.

41. The identity manager according to claim 40, wherein the basic entity information associated with the sector for the entity or the North American Industry Classification System for the entity includes any one of a subsector, an industry group, an industry, a national industry, or any combination of any of the preceding.

42. The identity manager according to claim 40, wherein the basic entity information associated with the standard industrial classification for the entity includes any one of a division, a major group, an industry group, an industry, or any combination of any of the preceding

43. The identity manager according to claim 28, wherein the basic entity information associated with the entity includes the at least one aspect of an address of the entity including any one of a street name, a street number, a city, a state or province, a postal code, an internet address; a telephone address; an e-mail address, or any combination of any of the preceding.

44. The identity manager according to claim 28, wherein the basic entity information associated with the entity includes the at least one aspect of a legal category for the entity including any one of an association, a bank, a collective, a cooperative, a corporation, a hybrid between a corporation and a partnership, an estate, a governmental institution, a partnership, a political party, a political action committee (PAC), a union, a trust, or any combination of any of the preceding.

45. The identity manager according to claim 44, wherein the governmental institution is a municipality, a state or province, a federal government, a national government, or any sector or combination of any of the preceding.

46. The identity manager according to claim 19, the validated database further includes transitory entity information.

47. The identity manager according to claim 46, wherein the transitory information includes any one of a date range, a temporary address, a primary domicile address, a secondary domicile address, a mobile phone number, a temporary location phone number, an internet address; an e-mail address, a transitory typical location range, a transitory extended location range, or any combination of any preceding.

48. The identity manager according to claim 72, wherein the temporary address or the primary domicile address or the secondary domicile address includes any one of a street address, a state or province, a city, a postal code, or any combination of any of the preceding.

49. The identity manager according to claim 19, the validated database further includes a confirmation control profile.

50. The identity manager according to claim 49, wherein the confirmation control profile includes an attribute to identify one or more associated confirmation contexts.

51. The identity manager according to claim 50, wherein the one or more associated confirmation contexts include any one of a critical-use context, semi-critical-use context, a non-critical-use context, or any combination of any of the preceding.

52. The identity manager according to claim 51, wherein the critical-use context including any one of a personal safety, a public safety, a medical safety, or any combination of any of the preceding further includes at least one controlled-access personal detail.

53. The identity manager according to claim 52, wherein the at least one controlled-access personal detail includes any one of an entity to notify in case of emergency, an entity to check with for confirmation assistance in case of emergency, a physical feature usable to confirm the entity's identity, an item carried by the entity and usable to confirm the entity's identity, or any combination of any of the preceding.

54. The identity manager according to claim 53, wherein the physical feature usable to confirm the entity's identity comprises a private physical feature.

55. The identity manager according to claim 50, wherein the the associated confirmation context is adapted to accommodate a variety of any one of frequencies of use, degrees of sensitivity of information used in a confirmation process, quantities of purchase or credit, associations of a natural-person entity and an group entity, transmissions of information to a confirming entity once an identity is confirmed, transmissions of information to a natural-person entity or an group entity once an identity is confirmed, uses for home security access, confirmations allowing a confirming entity to rapidly check a password given by an entity, or any combination of any of the preceding.

56. The identity manager according to claim 49, wherein the confirmation control profile further includes a keyword per record assignable by an entity so as to accommodate a controlled execution through a confirming entity account.

57. The identity manager according to claim 49, wherein the confirmation control profile further includes a date range assignable by an entity so as to accommodate a controlled execution.

58. The identity manager according to claim 49, wherein the confirmation control profile further includes any one of a location, location range, or any combination of any of the preceding assignable by an entity so as to accommodate a controlled execution.

59. The identity manager according to claim 49, further including a link usable in confirming an entity's identity and usable for obtaining data capable of assisting in resolving an issue relating to the entity's situation.

60. The identity manager according to claim 59, wherein the link is usable for obtaining health data capable of assisting in resolving a health issue involving the entity.

61. The identity manager according to claim 59, wherein the link is usable for obtaining data capable of assisting in resolving a safety issue involving the entity.

62. The identity manager according to claim 19, further including at least one biometric parameter, the at least one biometric parameter residing in any one of the validated database, an additional database within the identity manager, an additional database without the identity manager and with which the identity manager is adapted to communicate, or any combination of any of the preceding.

63. The identity manager according to claim 62, wherein the at least one biometric parameter includes any one of a physiological characteristic, a behavioral characteristic, or any combination of any of the preceding.

64. The identity manager according to claim 63, wherein the physiological characteristic includes a characteristic of any one of an iris, a fingerprint, a hand, a face, a voice, a retina, a DNA, an odor, an earlobe, a sweat pore, a lips, or any combination of any of the preceding.

65. The identity manager according to claim 64, wherein the physiological characteristic includes a characteristic of any one of an iris, a fingerprint, a hand, a voice, a retina, a DNA, or any combination of any of the preceding.

66. The identity manager according to claim 63, wherein the behavioral characteristic includes any one of a signature, a keystroke, a voice, a gait, or any combination of any of the preceding.

67. The identity manager according to claim 19, further including an account-control confirmer.

68. The identity manager according to claim 67, wherein the account-control confirmer includes a registered and confirmed entity other than the entity.

69. The identity manager according to claim 68, wherein the registered and confirmed entity includes any one of a spouse, a friend, or any combination of any of the preceding.

70. The identity manager according to claim 19, wherein the confirmation manager includes any one of a password access; an identity confirmation protocol; a confirmation request capable of being initiated by any one of an entity, a confirmer, or an entity and confirmer; a non-critical request confirmation request capable of being refused by an entity, a confirmer, or an entity and confirmer; a request log; a system capable of contacting an entity to assure an initiation of an authorized confirmation; a system capable of using a caller ID to assure an initiation of an authorized confirmation; a confirmation context verifier capable of verifying that a confirmation context in a request matches that of a control record defined by the entity; a request ID suppliable by a confirming entity and for facilitating a communication between the confirming entity and an entity; a password prompt; a test suppliable by a confirming entity and for carrying out by an entity; a geographical location comparer and evaluator; an access prompt for facilitating a reply by an entity through a confirming entity's account; a results evaluator capable evaluating factors involved in a confirmation; a confirmation score criteria definable by an entity and including an evaluation of results of factors involved in a confirmation, a reporting results of the factors involved in a confirmation, or any combination of any of the preceding.

71. The identity manager according to claim 70, wherein the request log includes any one of an identity of a requestor, an identity of an entity to be confirmed, an identity of a confirming entity, a date and time of a request, a date and time of execution, one or more confirmation contexts of a request, a keyword provided by an entity to be confirmed, a parameter provided for specific purposes, a memo notice for notifying an entity to be confirmed of the purpose of a confirmation, an alternate callback number for entity to be confirmed to access confirmation manager, a request status indicator, a request result, a final request result, or any combination of any of the preceding.

72. The identity manager according to claim 19, wherein the entity-controllable data further includes any one of an association profile, an entity description profile, an entity-controllable criterion usable for confirmation.

73. The identity manager according to claim 72, wherein the association profile includes any one of an additional entity other than the entity, an additional entity having a relationship to the entity, a type of relationship, a common relationship keywords, a password specific to a relationship, an indicator of a high level of trust, or any combination of any of the preceding.

74. The identity manager according to claim 73, wherein the additional entity having a relationship to the entity includes any one of a friend, a spouse, a sibling, a child, a parent, a business, or any combination of any of the preceding.

75. The identity manager according to claim 72, wherein the entity description profile includes a notice designatable by an entity for a public record and placable on any one of a virtual constituent list, a preference list, or any combination of the preceding; a notice designatable by an entity for specifying any one of a need, a preference, an interest, a requirement regarding a relationship with another entity or any combination of the preceding and useable during a confirmation; a deep profile description designatable by an entity and useable in verifying in a special circumstance; a free form entity description designatable by an entity for sharing with one or more designated other entities of any one of an interests, a skill, an activity, a belief, favorites, or any combination of the preceding; a personal infrastructure description relevant to an entity support structure including any one of an insurance account, a bank account, an utility account, medical service information, a will, a living will, a power of attorney, directions in case of emergency, or any combination of any of the preceding; or any combination of any of the preceding.

76. The identity manager according to claim 72, wherein the entity-controllable criterion includes any one of at least one entity specified prompt and an associated reply, a location having an area range relating to a primary address, a location having an area range relating to a transitory address, a location having an area range relating to a confirmation control, a location having an area range capable of being verified using a relative positioning type device, a confirmation context, a score criteria for a confirmation of an entity, a score criteria for a confirmation of other entities, or any combination of any of the preceding.

77. The identity manager according to claim 19, wherein the relative positioning type device includes a GPS type device.

78. The identity manager according to claim 19, further including a guest account capable of being used by any one of a confirming entity, an entity, an unregistered confirming entity, an unregistered entity, or an combination of any of the preceding.

79. The identity manager according to claim 19, further including any one of an account manager, a registrar-verifier, or any combination of any of the preceding.

80. The identity manager according to claim 79, wherein the registrar-verifier is adapted to be capable of any one of accessing the validated database, verifying the validated database; indicating a status of one or more items of information of the validated database, or any combination of any of the preceding.

81. The identity manager according to claim 19, wherein the identity manager is adapted to be capable of any one of setting controls for one or more prespecified contexts; setting controls for one or more prespecified frequencies of use; monitoring an entity defined password prompt and a reply for a confirmation context; granting law or medical personnel access to information of a more private nature so as to assist in situation relating to any one of personal safety, public safety, medical safety, monitoring an entity defined date range limitation, monitoring an entity defined keyword for allowing an entity access through a confirming entity account, granting a group entity authority to assist in a verification of entity information, granting a group entity authority to be assist in a verification of entity information, or any combination of any of the preceding;

82. The identity manager according to claim 19, further including a fraud detector.

83. The identity manager according to claim 82, wherein the fraud detector further includes or is adapted to be capable of any one of an alarm; a reporter; an investigator; monitoring activities of any one of an account manager, a confirmation manager, or any combination of any of the preceding; reporting a suspicious activity related to any one of an account manager, a confirmation manager, or any combination of any of the preceding; notifying an entity that a suspicious activity has been detected; investigating for the source of an attempt confirmed to be fraudulent, suspending an entity account when suspicious activity is detected; re-enabling an entity account upon a resolution of a suspicion, determining when a keyword has become too common; notifying an entity that a keyword has become too common.

84. The identity manager according to claim 83, wherein the suspicious activity includes any one of an attempt by two or more entities to claim an unique identifier that is the same; attempt to use information that proves untrue upon independent confirmation; a use of the identity manager in a way contrary to a historical behavior pattern; a use of the identity manager in a way contrary to an explicit instruction from the entity; an attempted access outside of a date range specified by an entity; a repeated failure to successfully confirm an identity; a cookie mismatch using web interface; a report from entity that entity wasn't actually involved in a successfully completed confirmation event; or any combination of any of the preceding.

85. An entity identity management system comprising:
(a) a validated database including entity-controllable data;
(b) a confirmation manager; and
(c) an interface.

86. A method for managing an identity of an entity, the method comprising the steps of:
(a) populating a database with entity information;
(b) validating at least a portion of the entity information of the database; and
(c) confirming the identity of the entity by using at least a portion of the validated entity information.

87. A method for managing an identity of an entity, the method comprising the steps of:
(a) populating a database with entity information;
(b) validating at least a portion of the entity information of the database;
(c) preselecting a manner in which the entity information is presented to confirm the identity of the entity; and
(d) confirming the identity of the entity by using at least a portion of the validated entity information in the preselected manner.

88. A computer useable medium and computer readable code embodied on said computer useable medium for causing an entity identity system to be managed by a user, the computer readable code comprising:
(a) computer readable program code devices configured to cause the computer to effect the receiving, over a communication network from a client machine, of a transmission provided by a user;
(b) computer readable program code devices configured to cause the computer to effect the accessing, from a database, of stored data of the entity identity system;
(c) computer readable program code devices configured to cause the computer to effect a populating of the database with entity information;
(d) computer readable program code devices configured to cause the computer to effect a validating of at least a portion of the entity information of the database;
(e) computer readable program code devices configured to cause the computer to effect preselecting by the user of manner by which the entity information is presented to confirm the identity of the entity;
(f) computer readable program code devices configured to cause the computer to effect a selecting of at least a portion of the entity information in the preselected manner; and
(g) computer readable program code devices configured to cause the computer to effect an analyzing of responses to the selected portion of the entity information of the database so as to facilitate confirming the identity of the entity.

89. An article of manufacture comprising a computer usable medium having computer readable program code means embodied therein for causing an entity identity to be managed, the computer readable program code means in said article of manufacture comprising:
(a) computer readable program code means for causing a computer to effect a populating of a database with entity information;
(b) computer readable program code means for causing the computer to effect a validating of at least a portion of the entity information of the database;
(c) computer readable program code means for causing the computer to effect a selecting of at least a portion of the entity information of the database; and
(d) computer readable program code means for causing the computer to effect an analyzing of responses to the selected portion of the entity information of the database so as to facilitate confirming the identity of the entity.

90. A computer useable medium and computer readable code embodied on said computer useable medium for causing an entity identity system to be managed by a user, the computer readable code comprising:
(a) computer readable program code devices configured to cause the computer to effect the receiving, over a communication network from a client machine, of a transmission provided by a user;
(b) computer readable program code devices configured to cause the computer to effect the accessing, from a database, of stored data of the entity identity system;
(c) computer readable program code devices configured to cause the computer to effect a populating of a database with entity information;
(d) computer readable program code devices configured to cause the computer to effect a validating of at least a portion of the entity information of the database;
(e) computer readable program code devices configured to cause the computer to effect a selecting of at least a portion of the entity information of the database; and
(f) computer readable program code devices configured to cause the computer to effect an analyzing of responses to the selected portion of the entity information of the database so as to facilitate confirming the identity of the entity.
